(19) United States
(12) Patent Application Publication
(10) Pub. No.: US 2018/0283998 A1
(43) Pub. Date: Oct. 4, 2018

(54) METHODS AND APPARATUS FOR REMOVAL OF SMALL VOLUME FROM A FILTRATION DEVICE

(71) Applicants: Mike Joseph Pugia, Ganger, IN (US); Zane Baird, Brigham City, UT (US); Zehui Cao, Carmel, IN (US)

(72) Inventors: Mike Joseph Pugia, Ganger, IN (US); Zane Baird, Brigham City, UT (US); Zehui Cao, Carmel, IN (US)

(21) Appl. No.: 15/941,059

(22) Filed: Mar. 30, 2018

Related U.S. Application Data
(60) Provisional application No. 62/480,365, filed on Apr. 1, 2017.

(51) Int. Cl. G01N 1/40; G01N 27/327; B01L 3/00

(52) U.S. Cl. CPC G01N 1/4077; G01N 27/3277; B01L 3/50273; B01L 2300/0681; B01L 2400/0463; B01L 2200/0647; G01N 2001/4088

(57) ABSTRACT

The invention provides a method of releasing a liquid from a porous matrix having at least one pore to a microfluidic surface having at least one liquid volume area and at least one exit hole, comprising: (a) filtering said liquid through said porous matrix; (b) removing said porous matrix and sealing the microfluidic surface having a liquid volume area; (c) releasing said liquid from the liquid volume area through the exit hole of the microfluidic surface by application of a dynamic force; and (d) collecting said liquid into a liquid receiving area. Additionally, there is provided an apparatus useful for processing liquid samples undergoing analytical assays which includes (a) a filtering device having a porous matrix affixed to a support structure; (b) a microfluidic surface having a liquid volume area and an exit hole connected to said filtering device; and (c) a liquid receiving area attached to said microfluidic surface.

This application claims the priority benefit under 35 U.S.C. section 119 of U.S. Provisional Patent Application No. 62/480,365 entitled “Methods And Apparatus For Removal Of Small Volume From A Filtration Device” filed on Apr. 1, 2017; and which is in its entirety herein incorporated by reference.

### BACKGROUND OF THE INVENTION

The invention relates to methods, apparatus and kits for analysis of small amounts of sample liquids (on the microliter (μL) scale or less) that contain only a few molecules of analyte (on the fentamolar (fM) scale or less). In some aspects the invention relates to methods, apparatus and kits for detecting one or more different populations of rare molecules in a sample suspected of containing one or more different populations of rare molecules and non-rare molecules. In some aspects, the invention relates to methods and kits for detecting one or more different populations of rare molecules that are freely circulating in samples. In some aspects, the invention relates to methods and kits for detecting one or more different populations of rare molecules that are associated with rare cells in a sample suspected of containing one or more different populations of rare cells and non-rare cells.

The detection of rare molecules in the range of 1 to 50,000 copies (fentamolar (fM) or less) cannot be achieved by conventional affinity assays, which require a number of molecular copies far above the numbers found for rare molecules. For example, immunoassays cannot typically achieve a detection limit of 1 picomolar (pM). Immunoassays are limited by the affinity binding constant of an antibody, which is typically not higher than 10⁻¹² (1 pM). Immunoassays require at least 100-fold antibody excess due to the off-rate being 10⁻¹³, and the solubility of the antibody protein limits driving the reaction to completion. As a typical sample volume is rarely greater than 10 μL, a concentration of 1 pM requires 60 million copies of a rare molecule for detection, far greater than the range for a rare molecule. The detection of circulating proteins that are not cell bound is also desirable. This same issue of solubility of the antibody prevents conventional immunoassays from reaching sub-attomolar levels.

The detection of rare molecules can be achieved by conventional nucleic acid assays. However, the target nucleic acids must be subjected to one or more lengthy purification steps and amplifications that can take several days for analysis time. For example, amplification techniques include, but are not limited to, enzymatic amplification such as, for example, polymerase chain reaction (PCR), ligase chain reaction (LCR), nucleic acid sequence based amplification (NASBA), Q-β-replicase amplification, 3SR (specific for RNA and similar to NASBA except that the RNAase-H activity is present in the reverse transcriptase), transcription mediated amplification (TMA) (similar to NASBA in utilizing two enzymes in a self-sustained sequence replication), whole genome amplification (WGA) with or without a secondary amplification such as, e.g., PCR, multiple displacement amplification (MDA) with or without a secondary amplification such as, e.g., PCR, whole transcriptome amplification (WTA) with or without a secondary amplification such as, e.g., PCR or reverse transcriptase PCR, for example.

The detection of rare molecules that are cell bound or included in a cell is important in medical applications such as, for example, diagnosis of many diseases. The detection of rare cells is also of great importance. The medical applications of cellular analysis require isolation of certain cells of interest, which typically represent only a small fraction of a sample under analysis. For example, circulating tumor cells (“CTCs”) are of particular interest in the diagnosis of metastatic cancers. In conventional methods, CTC are isolated from whole blood by first removing red blood cells (RBCs) by lyses. In a 10 mL blood sample, a few hundred CTCs are to be separated from about 800,000,000 white blood cells (“WBCs”). Therefore, methods with high separation efficiency and cell recovery rates are necessary.

The detection of rare molecules that are circulating in the sample and not cell bound, the so called “cell free” analysis, is important in medical applications such as, for example, diagnosis of many diseases. The medical applications of cell free analysis require isolation of certain rare molecule of interest, which typically represent only a small fraction of a sample under analysis. For example, proteins shed from cancer cells, like Her2Nue, are of particular interest in the diagnosis of metastatic cancers. In conventional methods, the Her2Nue protein is isolated from whole blood by first binding to an anti Her2Nue antibody immobilized onto a micron size particle and secondly removing the micron size particle from the unbound materials in the sample. Therefore, methods with high separation and washing efficiency of particle are necessary and highly desirable.

Size exclusion filtration is one method used for the separation and washing of cells or particles. Filtration relies on using a porous matrix such as microfluidic and porous matrix material. Filtration is also a useful method used to sort rare cells by size or nature. During filtration smaller non rare cells are lost and larger rare cells separated. However, filtration techniques can often only yield only a few rare cells for some important diseases, thus highly accurate and sensitive detection methods are required. For example, for a cancer patient a single to several thousand circulating tumor cells (CTCs) are typically seen in 10 mL of whole blood. The number of copies of a rare molecule can be significant at only tens of thousands of copies per cell for proteins of a single cell captured by filtration.

Rare cells can be analyzed down to the single cell level by conventional scanning microscopy. Antibodies with fluorescent labels can detect as few at 50,000 molecules at 1 attomolar (aM) for some proteins in a single cell. This is due to the extremely small sample detection volume (less than 1 nanoliter (nL)) of a microscopic analysis of a single cell. Additionally, as few as 1,000 molecules (fM) can be detected with antibodies after enzyme amplification (500-fold amplification). Further, molecular analysis (in-situ hybridization) of cells can be done down to a single molecule level due to the higher affinity of nucleic acid probes. However, even with automation of the scanning and analysis, the microscopy method can take 24 hours or more for each sample to be scanned. Additionally, all the rare cells with multiple images must be examined visually by the pathologist to determine the significance of protein amounts measured.

Mass Spectrometry (MS) is an extremely sensitive and specific technique and is very well suited for detecting small molecules (about 300 daltons (Da)) and medium sized molecules (about 3000 Da) at pM concentrations. MS has the ability to simultaneously measure hundreds (multiplexing) of highly abundant components present in complex biological media in a single assay without the need for labeled reagents. The method offers specificity until the biological media causes overlapping masses. Of the MS combined techniques (ionization and separation), triple quad mass spectrometry (MS-MS), liquid chromatography-tandem mass spectrometry (LC-MS/MS) is limited to small mass analytes and liquid chromatography-tandem mass spectrometry (LC-MS/MS) with multiple reaction monitoring (MRM) (LC-MRM-MS) is limited to high abundance proteins. In both cases the use of liquid chromatography makes automation difficult due to run times, cost, complexity and maintainability. Matrix-assisted laser desorption/ionization using a time-of-flight mass spectrometer (MALDI-TOF) combined technique is well suited for high sensitivity for low abundance molecules needed for rare molecular analysis; however, specificity for the biological media causes overlapping masses.

The current state of the art mass spectroscopy has several drawbacks, which keep MS from being competitive with routine affinity reaction systems. The noted problems are inability to separate markers of interest from sample interference (matrix over lapping peaks), loss of sensitivity due to background in clinical sample (picomolar (pM) reduced to nanomolar (nM)), the inability to work with small nL sample volumes as samples less than 1 microliters (μl) are inefficiently captured for ionization and inefficiently isolated from interfering peaks in complex samples such as blood. In addition, MS often has an inability to detect certain masses due to competition with other mass of the same mass being ionized. These drawbacks typically cause problems due to false results.

Another problem for mass spectral analysis is that quantitation of results requires mass to ionize readily; this can limit detection to smaller masses of less than 3 kilodaltons (kDa) with atoms that can be charged and made into parent ions. Proteins are typically greater than 10 kDa to 1000 kDa and are more difficult to ionize as parent ions. To achieve quantitative mass spectral analysis, the proteins must be broken into smaller fragments typically by proteolysis with enzymes like trypsin. However, the trypsinization reaction of proteins is not reproducible; not all proteins and bound forms can be fragmented; certain epitopes or forms of interest are fragmented and cannot be detected; and various components of the sample inhibit the activity of trypsin, for example. Another problem is that this peptide method often requires higher affinity antibodies than for a typical immunoassay. Another problem is that these fragments often do not relate to the clinical state as they are not the relevant molecule regions. It appears that this method of analysis remains a difficult and complex multistep process to automate and is noncompetitive with other detection technologies. Another problem is that these fragments have to be concentrated into small sample detection volume (less than 1 microliter down to 1 nanoliter (nL)) for analysis to occur.

Solutions to the above problems in mass spectroscopy are presented in Pugia provisional application Nos. 62/074,938, 62/286,155 and 62/222,940 the entire contents of which are incorporated by reference herein. In the '938 application, a releaseable mass labeling method allows detecting rare molecules in an enriched sample by using an affinity agent that is specific and an alteration agent to facilitate the formation of a mass spectrometry label that is used to measure the presence and/or amount of target rare molecules in the sample. This eliminates the problems in ionization differences. The release occurs by breakage of a disulfide bond. In the '155 application, a mass labeling method occurs with fragmentation in the mass spectrometer and not by breakage of a disulfide bond but a ketal bond allowing greater sensitivity in detecting rare molecules. In the '940 application, a filtration method is described which uses a method of releasing liquid from a porous matrix comprising at least one pore. The porous matrix is associated with a droplet-inducing feature, e.g a pore, that comprises the intersection of two surfaces. The angle at the intersection of the two surfaces is about 30° to about 150°. The method comprises exposing the liquid on the porous matrix to an electrical field to generate a hydrodynamic force for releasing droplets of the liquid through at least one pore of the porous matrix. The combination of these inventions allows amplified detection of rare molecule in small sample volumes.

However, the current approaches lack containment of the small volumes and expose the small volumes of liquids to the environment. The small liquid samples volumes are required for high sensitivity but are more prone to rapid evaporation. More rapid loss due to evaporation adds greatly to variability. Too much evaporation leads to non-result as no solvent is left to spray. The rapid evaporation also requires more rapid time to results which are faster than the speed of the analyzer to capture the result. Small sample volume (<1 uL) on a surface evaporate readily in few millisecond timeframes. The evaporation changes the concentration of mass labels on the porous matrix. Evaporation rates vary with humidity, temperature, surface area, ionic strength of liquid, organic content of liquid, the size of spray volume, atmospheric pressure, and other factors. The organic solvents used for analysis also are prone to rapid rate of evaporation. For rare molecules captured from enriched samples, the residual components of the samples, such as blood proteins, cause the filtration device surface energy to vary after processing samples. Surface energy differences impact the evaporation rate. Therefore, simple filtration does not allow accurate small sample volumes for measurement after isolation. This variability also limits the quantitation.

Approaches such as sealing wells causes too much head space to eliminate small volume evaporation. Addition of more spray liquid reduces sensitivity. Addition of higher evaporation rate liquids such as oil can protect the small volumes but the oils must not be miscible with the sample liquid e.g. water soluble, and be conductive. These oils also complicate the analysis by contamination. Alternative spray approaches such as DESI spray, use a solvent spray bombard the surface and reflect sample in solvent, but these types of spray are also prone to environmental impact. Utilization of water does slow down the evaporation rate however, as the sample volumes become smaller, <10 μL, this is not enough to slow evaporation from affecting the results of the analysis.

There is, therefore, a long felt need to develop methods and apparatus that provide for release of precise small amounts of detection liquid from a porous matrix and for delivery into a analyzer while avoiding loss of the detection liquid.

### SUMMARY OF THE INVENTION

The invention provides a method of releasing a liquid from a porous matrix having at least one pore to a microfluidic surface having at least one liquid volume area and at least one exit hole, said method comprising: (a) filtering said liquid through said porous matrix; (b) removing said porous matrix and sealing the microfluidic surface having a liquid volume area; (c) releasing said liquid from the liquid volume area through the exit hole of the microfluidic surface by application of a dynamic force; and (d) collecting said liquid into a liquid receiving area.

The invention further provides a method of releasing liquid droplets from a porous matrix having at least one pore to a microfluidic surface having at least one liquid volume area and at least one exit hole, said method comprising: (a) filtering said liquid droplets through said porous matrix; (b) removing said porous matrix and sealing the microfluidic surface having a liquid volume area; (c) releasing said liquid droplets from the liquid volume area through the exit hole of the microfluidic surface by application of a dynamic force; and (d) collecting said liquid droplets into a liquid receiving area.

The invention is also a directed to an apparatus useful for processing liquid samples undergoing analytical assays, said apparatus comprising: (a) a filtering device having a porous matrix affixed to a support structure; (b) a microfluidic surface having a liquid volume area and an exit hole connected to said filtering device; and (c) a liquid receiving area attached to said microfluidic surface.

Some examples in accordance with the principles described herein are directed to methods of releasing a liquid from a porous matrix having at least one pore into a microfluidic surface with liquid volume area and at least one exit hole capable of emitting sample upon application of a hydrodynamic force. The method comprises filtering the sample onto a porous matrix placed in the bottom of the liquid holding area, where the porous matrix is sealed to the microfluidic surface with liquid volume area having least one exit hole, and then applying a hydrodynamic force to move liquid droplets from the liquid holding area to a liquid receiving area.

Some examples in accordance with the principles described herein are directed to methods of detecting one or more different populations of target rare molecules in a sample suspected of containing one or more different populations of rare molecules and non-rare molecules. A concentration of the one or more different populations of target rare molecules is reacted with an affinity agent to form a retained affinity agent sample on a porous matrix. The retained affinity agent that comprises a specific binding partner that is specific for and binds to a target rare molecule of one of the populations of the target rare molecules. The retained affinity agent may be non-particulate or particulate and comprises an analytical label precursor that is also retained on the porous matrix after filtration, and which allows the formation of an analytical label from an analytical label precursor. Optionally an analytical label can be retained with the affinity agent on the porous matrix whether non-particulate or particulate. The liquid on the porous matrix is exposed to a hydrodynamic force to release liquid droplets from the porous matrix through or to the exit hole of the microfluidic surface. The liquid on the microfluidic surface can further be exposed to a great hydrodynamic force to release droplets of the liquid from the exit hole of the microfluidic device. The liquid droplets are subjected to analysis to determine the presence and/or amount of each different analytical label. The presence and/or amount of each different analytical label are related to the presence and/or amount of each different population of target rare molecules in the sample. Optional presence and/or amount of each different analytical label are related to the presence and/or amount of each different population of target rare molecules retained in the porous matrix or in a liquid receiving area.

### BRIEF DESCRIPTION OF THE DRAWINGS

The drawings provided herein are not to scale and are provided for the purpose of facilitating the understanding of certain examples in accordance with the principles described herein and are provided by way of illustration and not limitation on the scope of the appended claims.

FIGS. 1a and 1b are schematic cross-sections depicting an example of an apparatus, method or kit in accordance with the principles described herein for filtering the sample and reagents through a porous matrix adhered to the bottom of liquid holding area and associated with a microfluidic surface for liquid transfer. Referring to FIG. 1a, there is shown the position during filtration where reference numeral 1 is a liquid holding area with the attached porous matrix 2, and reference numeral 3 is the microfluidic surface with the liquid holding area for liquids to be transferred from the porous matrix through the exit hole by hydrodynamic force. In FIG. 1b, there is shown the removal of the porous matrix from microfluidic surface 3; where 1 represents the liquid holding area with the attached porous matrix 2.

FIGS. 2a and 2b show another schematic cross-section depicting an example of an apparatus, method or kit in accordance with the principles described herein for collecting samples and filtering liquid reagents through a porous matrix in the bottom of liquid holding area which are removable from a microfluidic surface with liquid holding area. FIG. 2a shows the position of liquid holding area attached to the microfluidic surface where reference numeral 4 is the liquid holding area with attached porous matrix, where item 5 is a liquid reagent added to the liquid holding area, where reference numeral 6 is the porous matrix, and where reference numeral 7 is a microfluidic surface for liquid to be transfer through the use of a hydrodynamic force. FIG. 2b shows the position of a sample collected into a capillary attached on top of a second liquid holding area with sample capillary attached after sample collection to the first liquid holding area with porous matrix where reference numeral 8 is the capillary for sample collection, where liquid reagent 9 is added to sample capillary, where sample 10 is in capillary; where item 11 is the liquid holding area with attached porous matrix, where item 12 is the porous matrix, and where item 13 is microfluidic surface for liquid to be transfer through by hydrodynamic force.

FIG. 3 illustrates another example schematic cross-section of an apparatus, method or kit in accordance with the principles described herein for collecting droplets of the liquid for analysis from the porous matrix and liquid holding area into a liquid receiving area. FIG. 3 shows the position of porous matrix and liquid holding area associated with the microfluidic surface and the liquid receiving area where reference numeral 14 is the liquid holding area with attached porous matrix 15. The apparatus also includes a microfluidic surface 16 with liquid volume area and exit for liquid to be transferred using a hydrodynamic force and liquid receiving area 17 for collection of liquid droplets for analysis.

FIG. 4 is an additional schematic in cross-section depicting an example of the apparatus, method or kit in accordance with the principles described herein for collecting the sample and filtering liquid reagents through an array of liquid holding areas with attached porous matrix 18, and which is associated with a removable microfluidic surface applied as one piece to the bottom of array of liquid holding areas 19. In this example, a gasket 20 can be applied for a liquid impermeable seal between the microfluidic surface and the liquid holding areas with attached porous matrix. The microfluidic surface is connected to a manifold 21 for applying positive or negative hydrodynamic force.

FIG. 5 is another schematic in cross-section depicting an example of an apparatus, method or kit in accordance with the principles described herein for collecting the sample and filtering liquid reagents through individual liquid holding area with porous matrix 22 which are associated to a removable microfluidic surface 23 applied to the bottom of each liquid holding area and which is further associated to a holder 24 which can serve as manifold for applying positive or negative hydrodynamic force or for transport of individual liquid holding area with porous matrix.

### DETAILED DESCRIPTION OF THE INVENTION

### General Discussion

Methods, apparatus and kits in accordance with the principles described herein have application in any situation where release of precise small volumes of liquid on a porous matrix is required. Examples of such applications include, by way of illustration and not limitation, detection of target rare molecules, non-rare molecules, non-rare cells and rare cells, for example. The examples in accordance with the principles described herein, are directed to methods of releasing liquid droplets from a porous matrix to a surface with liquid volume area and at least one exit hole, which method comprises exposing the liquid to a hydrodynamic force and hydrodynamic force generator to release droplets of the liquid from the liquid volume area into the liquid receiving area.

Examples in accordance with the principles described herein are directed to apparatus, methods and kits comprising a porous matrix with at least one pore and associated liquid holding area and microfluidic surface. The apparatus is capable of moving liquid with a hydrodynamic force through the porous matrix from the liquid holding area to a liquid receiving area. The liquid droplets can be stopped and held in the porous matrix and microfluidic surface and then moved on to the liquid receiving area. The apparatus, methods and kits also include liquid receiving areas, sample capillaries and holders that can be associated surfaces.

Examples in accordance with the principles described herein are directed to apparatus, methods and kits for the collection of samples that captures rare molecules and cells onto a porous matrix by size exclusion filtration of cells or particles, and allows treatment of sample with liquids. The liquid holding area can be sealed with surfaces prior or after treatment with liquid reagents. The sample can be added in a sample capillary placed at bottom of the additional liquid holding area which can be associated with liquid holding area with the porous matrix.

Examples in accordance with the principles described herein are directed to apparatus, methods and kits for analysis of liquids containing rare molecules of interest or analytical labels. Rare molecules or analytical labels of interest are removed from a liquid holding area through a porous matrix and microfluidic surface and into a liquid receiving area by application of a hydrodynamic force able to expel the liquid droplet to the liquid receiving area. Exposing the apparatus to a hydrodynamic force releases liquid droplets from the porous matrix through the microfluidic surface exit hole into a liquid receiving area. Liquids droplets and porous matrix containing rare molecule and analytical labels are analyzed as samples.

Examples in accordance with the principles described herein are directed to apparatus, methods and kits for analysis of liquids containing rare molecules of interest or analytical labels. Rare molecules or analytical labels of interest are retained on the porous matrix and separated from liquid removed from porous matrix. Retained molecules or analytical labels of interest are analyzed directly on the porous matrix by analytical methods.

The term “liquid” refers to a “liquid sample”, a “liquid reagent”, “spray liquid”, an “analysis liquid” or a “liquid droplet” that contains analytical labels, rare molecules, rare cells or reagents.

The terms “liquid area” refers to areas capable of holding a liquid; such as areas over the porous matrix as a “liquid holding area”, or areas in the microfluidic surface with a defined liquid volume as a “liquid volume area”, or areas under the microfluidic surface able to capture expelled liquid as a “liquid receiving area”. As mentioned above, the liquid volume area is used to hold a liquid droplet. The term “liquid droplet” means a discrete liquid volume, surrounded in part by a surface of the liquid area and in part by air.

The term “associated with” means connect by adhesion, force or fit. As mentioned above, the porous matrix is “associated with” a liquid holding area and a microfluidic surface. In some examples the porous matrix is permanently fixed to a liquid holding area by an adhesive or bonding method. In other examples the porous matrix is permanently fixed to a “holder” which is associated with a liquid holding area and a microfluidic surface. In other examples, additional holders are capable of associating with the “microfluidic surface”, “liquid holding area” or “liquid receiving area” but are not permanently fixed to these surfaces. The “holder” has a surface that facilitate contact with associated surfaces and can be removed without use of a gasket for sealing.

The term “holder” refers a non-porous material capable of being permanently fixed to the porous matrix or capable of being associated with the “microfluidic surface”, “liquid holding area” or “liquid receiving area” but is not permanently affixed to these surfaces. The “holder” has a surface that facilitate contact with associated surfaces and can be removed or replaced.

The term “hydrodynamic force” is a force that drives a liquid to move from the porous membrane to the microfluidic exit hole and on to the liquid receiving area. Additionally, this force can drive a “liquid sample” from a “sample capillary” to the porous membrane. A “hydrodynamic force generator” is a means to generate the hydrodynamic force.

The term “sample capillary” refers to a defined area providing a capillary force to draw in a volume of liquid. The “sample capillary” is placed at the bottom of the additional liquid holding area which can be associated with liquid holding area with the porous matrix.

The term “analytical label” refers to an optical, mass, or electrochemical label capable of being imaged or detected on either on the porous matrix or the liquid droplet.

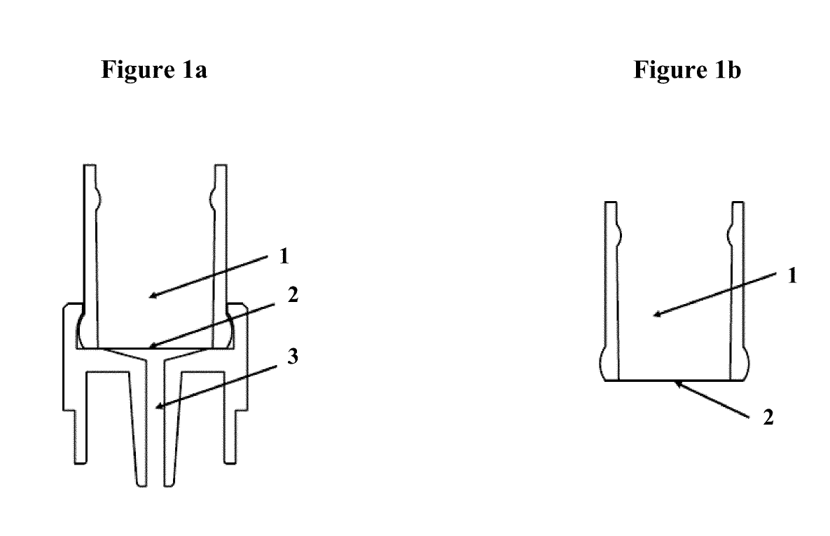

An example of an apparatus, method and kit for filtering the sample and reagents through a porous matrix adhered to the bottom of liquid holding area and associated to a microfluidic surface for liquid transfer is illustrated in FIGS. 1a and 1b. FIG. 1a shows the position during filtration where 1 is the liquid holding area with attached porous matrix 2, and microfluidic surface 3 with liquid volume area for liquids to be transferred through the porous matrix 2, through the exit hole using a hydrodynamic force. FIG. 1b shows the removal of porous matrix 2 from the microfluidic surface 3.

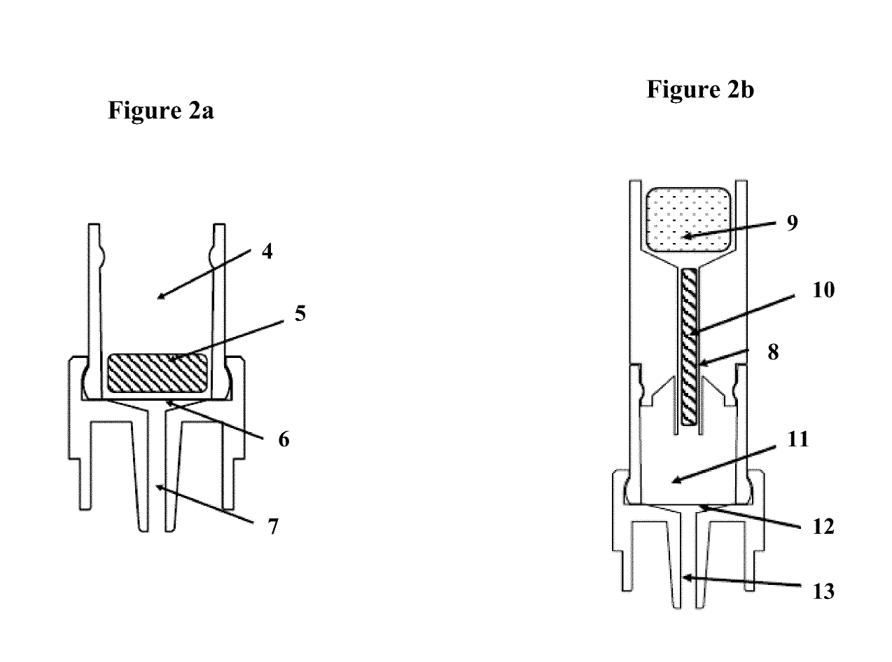

An example of an apparatus, method or kit for collecting samples and filtering liquid reagents through a porous matrix in the bottom of a liquid holding area which are removable from a microfluidic surface with liquid holding area is depicted in FIGS. 2a and 2b. FIG. 2a shows the position of the liquid holding area attached to the microfluidic surface where 4 is the liquid holding area with attached porous matrix 6, where 5 is the liquid reagent added to the liquid holding area, where 6 represents the porous matrix, and 7 is the microfluidic surface for liquid to be transferred through by means of a hydrodynamic force. FIG. 2b shows the position of a sample collected into a capillary attached on top of a second liquid holding area with sample capillary attached after sample collection to the first liquid holding area with porous matrix where reference numeral 8 is the capillary for sample collection, where liquid reagent 9 is added to sample capillary, where sample 10 is in capillary; where 11 represents the liquid holding area with attached porous matrix 12, and 13 is the microfluidic surface for liquid to be transferred through by a hydrodynamic force.

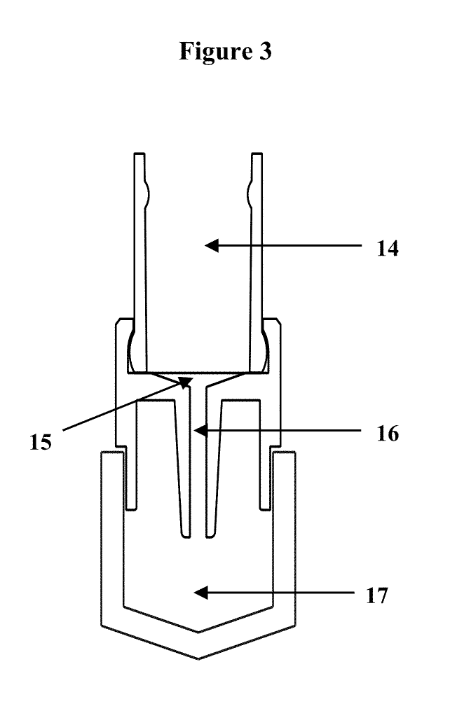

Another example of an apparatus, method or kit in accordance with the principles described herein for collecting droplets of the liquid for analysis from the porous matrix and liquid holding area into a liquid receiving area is depicted in FIG. 3. FIG. 3 shows the position of porous matrix 15 and liquid holding area 14 associated to a microfluidic surface 16 and the liquid receiving area 17.

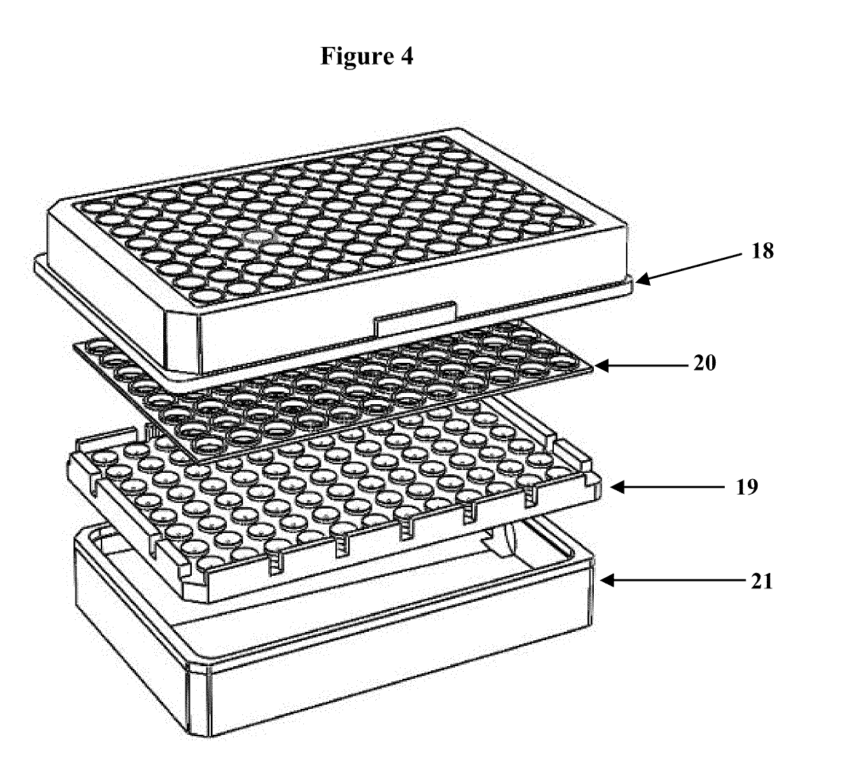

FIG. 4 represents a further example of an apparatus, method or kit in accordance with the principles described herein for collecting the sample and filtering liquid reagents through an array of liquid holding areas with porous matrix 18 attached, and which is associated with a removable microfluidic surface applied as one piece to the bottom of the array of liquid holding areas 19. In this example, a gasket 20 can be applied as a liquid impermeable seal between microfluidic surface and liquid holding areas with the attached porous matrix. The microfluidic surface 19 can be connected to a manifold for applying a positive or negative hydrodynamic force.

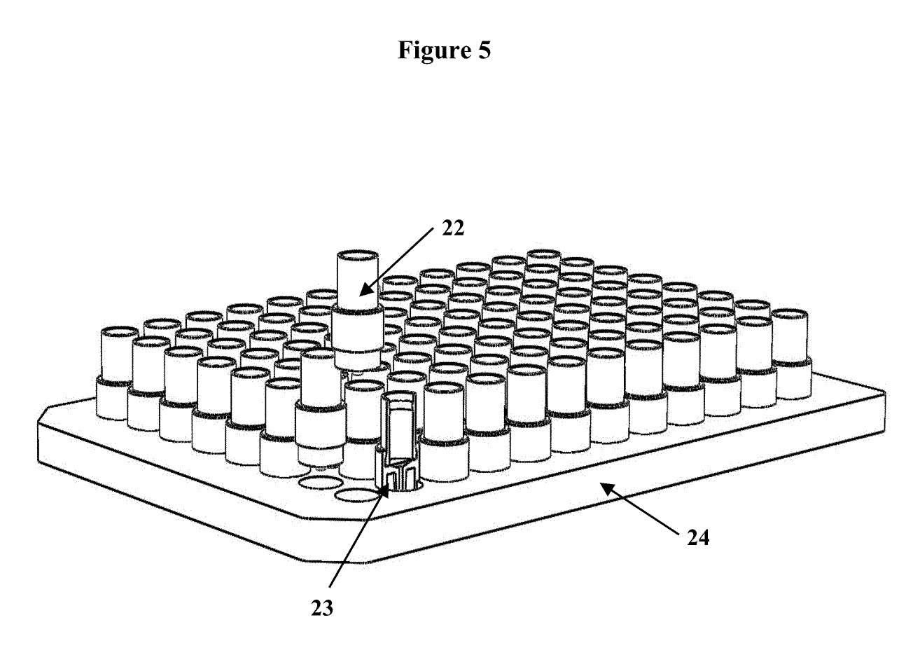

FIG. 5 is another further example of an apparatus, method or kit for collecting the sample and filtering liquid reagents through individual liquid holding area with porous matrix 22 which is associated to a removable microfluidic surface 23 applied to the bottom of each liquid holding area and which is further associated to a holder 24 which can serve as a manifold for applying positive or negative hydrodynamic force or for transport of individual liquid holding area with porous matrix.

### Examples of Porous Matrix

The porous matrix is a solid, material, which is impermeable to liquid except through one or more pores of the matrix. The porous matrix may be comprised of an organic or inorganic, water insoluble material. The porous matrix is non-bibulous, which means that the porous matrix is incapable of absorbing liquid. In some examples, the amount of liquid absorbed by the porous matrix is less than about 2% (by volume), or less than about 1%, or less than about 0.5%, or less than about 0.1%, or less than about 0.01%, or 0%. The porous matrix is non-fibrous, which means that the porous matrix is at least 95% free of fibers, or at least 99% free of fibers, or at least 99.5%, or at least 99.9% free of fibers, or 100% free of fibers.

The porous matrix can have any of a number of shapes such as, for example, track-etched, or planar or flat surface (e.g., strip, disk, film, matrix, and plate). The matrix may be fabricated from a wide variety of materials, which may be naturally occurring or synthetic, polymeric or non-polymeric. The shape of the porous matrix is dependent on one or more of the nature or shape of holder for the porous matrix, of the microfluidic surface, of the liquid holding area, of cover surface, for example. In some examples the shape of the porous matrix is circular, oval, rectangular, square, track-etched, planar or flat surface (e.g., strip, disk, film, membrane, and plate), for example.

The porous matrix may be fabricated from a wide variety of materials, which may be naturally occurring or synthetic, polymeric or non-polymeric. Examples, by way of illustration and not limitation, of such materials for fabricating a porous matrix include plastics such as, for example, polycarbonate, poly (vinyl chloride), polyacrylamide, polyalkylacrylate, polyethylene, polypropylene, poly-(4-methylbutene), polystyrene, polyalkylmethacrylate, poly(ethylene terephthalate), nylon, poly(vinyl butyrate), poly(chlorotrifluoroethylene), poly(vinyl butyrate), polyimide, polyurethane, and parylene; silanes; silicon; silicon nitride; graphite; ceramic material (such, e.g., as alumina, zirconia, PZT, silicon carbide, aluminum nitride); metallic material (such as, e.g., gold, tantalum, tungsten, platinum, and aluminum); glass (such as, e.g., borosilicate, soda lime glass, and PYREX®); and bioresorbable polymers (such as, e.g., poly-lactic acid, polycaprolactone and polyglycoic acid); for example, either used by themselves or in conjunction with one another and/or with other materials. The material for fabrication of the porous matrix and holder are non-bibulous and does not include fibrous materials such as cellulose (including paper), nitrocellulose, cellulose acetate, rayon, diacetate, lignins, mineral fibers, fibrous proteins, collagens, synthetic fibers (such as nylons, dacron, olefin, acrylic, polyester fibers, for example) or, other fibrous materials (glass fiber, metallic fibers), which are bibulous and/or permeable and, thus, are not in accordance with the principles described herein. The material for fabrication of the porous matrix and holder may be the same or different materials.

The porous matrix for each liquid holding area comprises at least one pore and no more than about 2,000,000 pores per square centimeter (cm²). In some examples, the number of pores of the porous matrix per cm² is 1 to about 2,000,000, or 1 to about 1,000,000, or 1 to about 500,000, or 1 to about 200,000, or 1 to about 100,000, or 1 to about 50,000, or 1 to about 25,000, or 1 to about 10,000, or 1 to about 5,000, or 1 to about 1,000, or 1 to about 500, or 1 to about 200, or 1 to about 100, or 1 to about 50, or 1 to about 20, or 1 to about 10, or 2 to about 500,000, or 2 to about 200,000, or 2 to about 100,000, or 2 to about 50,000, or 2 to about 25,000, or 2 to about 10,000, or 2 to about 5,000, or 2 to about 1,000, or 2 to about 500, or 2 to about 200, or 2 to about 100, or 2 to about 50, or 2 to about 20, or 2 to about 10, or 5 to about 200,000, or 5 to about 100,000, or 5 to about 50,000, or 5 to about 25,000, or 5 to about 10,000, or 5 to about 5,000, or 5 to about 1,000, or 5 to about 500, or 5 to about 200, or 5 to about 100, or 5 to about 50, or 5 to about 20, or 5 to about 10, for example. The density of pores in the porous matrix is about 1% to about 20%, or about 1% to about 10%, or about 1% to about 5%, or about 5% to about 20%, or about 5% to about 10%, for example, of the surface area of the porous matrix. In some examples, the size of the pores of a porous matrix is that which is sufficient to preferentially retain liquid while allowing the passage of liquid droplets formed in accordance with the principles described herein. The size of the pores of the porous matrix is dependent on the nature of the liquid, the size of the cell, the size of the capture particle, the size of mass label, the size of an analyte, the size of label particles, the size of non-rare molecules, and the size of non-rare cells, for example. In some examples the average size of the pores of the porous matrix is about 0.1 to about 20 microns, or about 0.1 to about 5 microns, or about 0.1 to about 1 micron, or about 1 to about 20 microns, or about 1 to about 5 microns, or about 1 to about 2 microns, or about 5 to about 20 microns, or about 5 to about 10 microns.

Pores within the matrix may be fabricated in accordance with the principles described herein, for example, microelectromechanical (MEMS) technology, metal oxide semiconductor (CMOS) technology, micro-manufacturing processes for producing micro-sieves, laser technology, irradiation, molding, and micromachining, for example, or a combination thereof.

The porous matrix is associated to a liquid holding area. In some examples the porous matrix is permanently fixed to a liquid holding area by an adhesive or bonding method. The porous matrix permanently fixed to a liquid holding area is associated with the microfluidic surface. In other examples the porous matrix is permanently fixed to a porous matrix “holder” which is associated with the liquid holding area and microfluidic surface. The porous matrix can be associated to the bottom of the liquid holding area and top of microfluidic surface by means of force or fit with or without use of a gasket.

The porous matrix may be permanently attached to a holder by adhesive or bonding method such as ultrasonic bonding, UV bonding, thermal bonding, mechanical fastening or through use of permanent adhesives such as drying adhesive like polyvinyl acetate, pressure-sensitive adhesives like acrylate-based polymers, contact adhesives like natural rubber and polychloroprene, hot melt adhesives like ethylene-vinyl acetates, and reactive adhesives like polyester, polyol, acrylic, epoxies, polyimides, silicones rubber-based and modified acrylate and polyurethane compositions, natural adhesive like dextrin, casein, lignin. The plastic or the adhesive can be electrically conductive materials and the conductive material coatings or materials can be patterned across specific regions of the hold surface.

### Examples of Holder

The term “holder” generally refers to a non-porous material capable of being permanently attached to the porous matrix or capable of being associated with the “microfluidic surface”, “liquid holding area” or “liquid receiving area” but is not permanently fixed to these surfaces. The “liquid receiving area” can be a well, vial, surface or inside an analyzer. The “holder” has a surface that facilitates contact with associated surfaces and can be removed or replaced. Complete contact can be accomplished by mechanical fit, adhesion or compression gaskets. This complete contact is dependent on the shape of the holder, the shape of the liquid area, the shape of the microfluidic surface, the surfaces of the liquid area or microfluidic surface, and the surfaces of the porous matrix.

In some examples, the porous matrix in the holder is associated with the microfluidic surface and liquid holding well. In other examples, the porous matrix is adhered to the liquid holding well in a holder that is associated with the microfluidic surface. In other examples, the holder is associated with the microfluidic surface, the porous matrix is adhered to the liquid holding area and a liquid receiving area. In still other examples, the holder is changed and replaced during a method, for example after moving liquids through the porous matrix and microfluidic surface and before collecting liquid droplet in the liquid receiving area. In still other examples, the holder is used to transport samples collected on the porous matrix.

The holder may be constructed of any suitable material that is compatible with the material of the porous matrix. Examples of such materials include, by way of example and not limitation, any of the materials listed above for the porous matrix. The material for the housing and for the porous matrix may be the same or may be different. The holder may also be constructed of metal, glass or molded plastic such as like polystyrene, polyethylenes; thermosets, elastomers, films, glass or other non-porous materials. Some examples of plastic materials, but not all inclusive, include polyalkylene, polyolefins, poly carbonates, epoxies, Teflon®, PET, chloro-fluoroethylenes, polyvinylidene fluoride, PE-TFE, PE-CTFE, liquid crystal polymers, Mylar®, polyester, polymethylpentene, polyphenylene sulfide, and PVC plastic films. The plastic film can be metallized such as with aluminum. The plastic films should have relative low moisture transmission rate, e.g. 0.001 mg per m²-day to be used.

The porous matrix associated with a liquid holding area and a microfluidic surface can be part of a filtration module where the apparatus uses a holder as part of an assembly for convenient use during filtration and transportation of specimens. The porous matrix and microfluidic surface can be separated and this association can be through direct contact with a holder or through an intermediate gasket or layer to allow such as force fit. The porous matrix with the liquid holding area and microfluidic surface can additionally be placed in a holder for application of a hydrodynamic force or transport. The holder does not contain pores and has a surface which facilitates contact with associated surfaces but is not permanently attached to these surfaces and can be removed.

The holder maybe constructed of gasket material or used as intermediate gasket materials. A top gasket maybe applied to the holder between the liquid holding area and microfluidic surface. A bottom gasket maybe applied between the microfluidic surface between liquid receiving area. A bottom gasket maybe applied to the holder between a top or bottom manifold for vacuum. A gasket is a flexible material that facilities complete contact upon compression. Examples of gasket shapes include a flat, embossed, patterned, or molded sheets, rings, circles, ovals, with cut out areas to allow sample to flow from porous matrix to vacuum manifold. Examples of gasket materials include paper, rubber, silicone, metal, cork, felt, neoprene, nitrile rubber, fiberglass, polytetrafluoroethylene like PTFE or Teflon or a plastic polymer like polychlorotrifluoroethylene.

### Examples of Hydrodynamic Forces

In accordance with the principles described above, hydrodynamic forces are applied to move the liquid through the porous matrix and microfluidic surface to liquid receiving area. Examples of hydrodynamic forces include gravity, vacuum, centrifugal force, air pressure, piezo electric, electrical field or capillary force. The application of hydrodynamic force allows the liquid to move from one liquid area to another liquid area. The term to “move”, means to spray, remove or eject the liquid from one liquid area to another liquid area whereby the liquid leaves a liquid area to enter a new liquid area occupied by air, gas, vacuum, liquid or particles.

As mentioned above, the porous matrix is associated with the liquid holding area directly or in its holder and a microfluidic surface. The phrase “associated with” means that the features are attached to one another by direct contact, for example, by fit, force or shape. The term “point of contact” means the point or series of points where the two surfaces touch one another. The point of contact of the surfaces depends on the shape of each of the surfaces such as, for example, the matrix, the liquid holding area, the microfluidic surface and cover surface feature and may be linear, circular, oval, for example, or a combination thereof. The point of contact can be facilitated by a gasket, or deformation of the associated surfaces. The hydrodynamic forces applied are dependent on the point of contact between the associated surfaces. The hydrodynamic force is generally reduced as the point of contact increases creating an air tight seal.

The hydrodynamic forces applied are also dependent on the nature of the porous matrix and the microfluidic surfaces. Generally, greater hydrodynamic forces are needed to move liquids as porous matrix or microfluidic surfaces become more hydrophobic. Generally, greater hydrodynamic forces are needed to move liquids as the number and sizes of pores or exit holes are reduced in the porous matrix or microfluidic surfaces. Generally, greater hydrodynamic forces are needed to move liquids through more restrictive geometries and shapes in the microfluidic surface. The liquid droplets can be stopped and held in the porous matrix or microfluidic surface when the surfaces, pores, exit holes, geometries, or shapes become restrictive enough to exceed the hydrodynamic force applied. In this case, the hydrodynamic forces required to move liquid past the stop needs to increase and then the liquid can be moved to the liquid receiving area. The shape, porosity, hydrophobicity and geometry of the porous matrix and the microfluidic surfaces can be adjusted to cause this change in hydrodynamic force required to pass the stop. The liquid held in the liquid volume area is removed by application of a greater hydrodynamic force.

In some examples, hydrodynamic forces are applied to the concentrated and treated sample on the porous matrix to facilitate passage of non-rare cells, non-rare molecules, uncaptured affinity agents or uncaptured particles through the porous matrix. The level of vacuum applied is dependent on one or more of the nature and size of the different populations of biological particles, the nature of the porous matrix, and the size of the pores of the porous matrix, for example. In some examples, the level of vacuum applied is about 1 millibar to about 100 millibar, or about 1 millibar to about 80 millibar, or about 1 millibar to about 50 millibar, or about 1 millibar to about 40 millibar, or about 1 millibar to about 30 millibar, or about 1 millibar to about 25 millibar, or about 1 millibar to about 20 millibar, or about 1 millibar to about 15 millibar, or about 1 millibar to about 10 millibar, or about 5 millibar to about 80 millibar, or about 5 millibar to about 50 millibar, or about 5 millibar to about 30 millibar, or about 5 millibar to about 25 millibar, or about 5 millibar to about 20 millibar, or about 5 millibar to about 15 millibar, or about 5 millibar to about 10 millibar, for example.

In some examples the vacuum is an oscillating vacuum, which means that the vacuum is applied intermittently at regular of irregular intervals, which may be, for example, about 1 second to about 600 seconds, or about 1 second to about 500 seconds, or about 1 second to about 250 seconds, or about 1 second to about 100 seconds, or about 1 second to about 50 seconds, or about 10 seconds to about 600 seconds, or about 10 seconds to about 500 seconds, or about 10 seconds to about 250 seconds, or about 10 seconds to about 100 seconds, or about 10 seconds to about 50 seconds, or about 100 seconds to about 600 seconds, or about 100 seconds to about 500 seconds, or about 100 seconds to about 250 seconds, for example. In this approach, vacuum is oscillated at about 0 millibar to about 10 millibar, or about 1 millibar to about 10 millibar, or about 1 millibar to about 7.5 millibar, or about 1 millibar to about 5.0 millibar, or about 1 millibar to about 2.5 millibar, for example, during some or all of the application of vacuum to the blood sample. Oscillating vacuum is achieved using an on-off switch, for example, and may be conducted automatically or manually.

Contact of the treated sample with the porous matrix is continued for a period-of-time sufficient to achieve retention of the target rare cells or the particle-bound target rare molecules on a surface of the porous matrix to obtain a surface of the porous matrix having different populations of target rare cells or the particle-bound target rare molecules as discussed above. The period of time of contact can be used for incubation of reactions and is dependent on one or more of the nature and size of the different populations of target rare cells or particle-bound target rare molecules, the nature of the porous matrix, the ability to stop and hold the liquid, the shape and geometry of the microfluidic surface, the size of the pores of the porous matrix, the level of vacuum applied to the sample on the porous matrix, the volume to be filtered, and the surface area of the porous matrix. In some examples, the period of contact is about 1 minute to about 1 hour, about 5 minutes to about 1 hour, or about 5 minutes to about 45 minutes, or about 5 minutes to about 30 minutes, or about 5 minutes to about 20 minutes, or about 5 minutes to about 10 minutes, or about 10 minutes to about 1 hour, or about 10 minutes to about 45 minutes, or about 10 minutes to about 30 minutes, or about 10 minutes to about 20 minutes, for example.

### Examples of Liquid Areas

In accordance with the principles described above, the “liquid area” is used to hold a liquid; such as in areas over the porous matrix as a “liquid holding area”, or in areas over the sample capillary as a “liquid holding area”, or in defined volume areas in the microfluidic surface as a “liquid volume area”, or in areas under the microfluidic surface able to capture expelled liquid as a “liquid receiving area”. A liquid volume area can be any shape with such as a well, cylinder, cone, rectangle or other geometry. As mentioned above, the liquid volume area is used to hold a liquid droplet. The term “liquid droplet” means a discrete liquid volume, surrounded in part by a surface of the liquid area and in part by air. The “liquid droplet” held in liquid volume area is removed by application of hydrodynamic force. The liquid volume area can contain liquids such as biological sample, a liquid reagent, an analysis liquid that contains analytical labels, rare molecules, tissue, cells, fibrous, materials particles, air, gas, vacuum, or other components used in methods and kits. The “liquid area” may be constructed of any material suitable for a holder, as described above

The term “sample capillary” refers to a defined area providing a capillary force to draw in a volume of liquid. The sample can be added in sample capillary placed at the bottom of the additional liquid holding area which can be associated with a liquid holding area with the porous matrix. The sample can be added in sample capillary placed at the bottom of the additional liquid holding area which can be associated with the liquid holding area with the porous matrix. The “sample capillary” may be constructed of any material suitable for the holder, as described above.

As mentioned above, “liquid holding area”, “microfluidic surface”, and “liquid receiving area” can be associated with each other. The points of contact do not obstruct the flow of liquid through the porous matrix and is in complete contact at the edges of the porous matrix such that liquid does not exit the walls of the liquid holding area, microfluidic surface, adhesive or manifold. Complete contact can be accomplished by mechanical fit, adhesion or compression gaskets using the materials described above. This complete contact is not permanent and the surface can be detached. This point of contact is dependent on the shape of the porous matrix, the sample of the liquid area, the surfaces of the bottom wall of the liquid area and the surfaces of the top of the holder for the porous matrix.

The liquid areas can be a structure such as wells, cylinders, cones, rectangles or other geometries made of molded plastics such as thermoplastics, like polystyrene, polyethylenes, thermosets, elastomers or other non-porous materials such as those used for the holder. The volume of the liquid area is dependent on the nature of liquid samples, the nature of the microfluidic surface, the nature and size of the porous matrix, the spray liquid, the nature of the capture particle or cell, the analyte concentrations and the analytical label concentration. The liquid area can hold a defined volume of liquid, which allows a defined liquid droplet volume. In some examples the volume of the liquid area is about 10 nanoliter(s) (nL) to about 1000 microliters (μL), or about 10 μL to about 100 nanoliters (nL), or about 10 μL to about 50 nL, or about 10 μL to about 100 nL, or about 1000 μL to about 500 nL, or about 10 μL to about 10 μL. In some examples where the liquid holding areas are circular, the diameter of the liquid holding area is about 5 micrometers (μm) to about 40 millimeters (mm), or about 5 μm to about 500 μm, or about 500 μm to about 2 mm, or about 2 mm to about 40 mm.

The liquid areas can be an array of liquid areas wherein each can be used for collecting a different sample or used for filtering different liquid reagents. For example, an array of liquid holding areas with porous matrix can be associated to an array of microfluidic surfaces with liquid volume areas and an array of liquid receiving areas. The arrays can be associated with sealing gasket by fit and form. The array of liquid areas can be in a holder before filtration which is also removed after filtration or in a holder after filtration.

The array can comprise 2 to about 100,000 liquid holding areas, or 2 to about 50,000 liquid holding areas, or 2 to about 10,000 liquid holding areas, or 2 to about 5,000 liquid holding areas, or 2 to about 2,500 liquid holding areas, or 2 to about 1,000 liquid holding areas, or 2 to about 500 liquid holding areas, or 2 to about 100 liquid holding areas, or 2 to about 50 liquid holding areas, or about 10 to about 100,000 liquid holding areas, or about 10 to about 50,000 liquid holding areas, or about 10 to about 10,000 liquid holding areas, or about 10 to about 5,000 liquid holding areas, or about 10 to about 2,500 liquid holding areas, or about 10 to about 1,000 liquid holding areas, or about 100 to about 10,000 liquid holding areas, or about 100 to about 5,000 liquid holding areas, or about 100 to about 2,500 liquid holding areas, or about 5,000 to about 10,000 liquid holding areas, or about 2,500 to about 7,500 liquid holding areas, for example.

### Examples of Liquids

As mentioned above the term “liquid” refers a “liquid sample” containing the rare molecules or cells for analysis, a “liquid reagent” contains reagents for conducting the method, an “analysis liquid” that contains analytical labels or/and, rare molecules, a “liquid droplet” that is a discrete volume of liquid, or a “spray liquid” that contains an analytical label. The liquid can contain the molecules, tissue, cells, particles, gases, cell culture medium, or other components used in methods and kits. The liquid can also contain particles and fibers such as separation media, organic particle, inorganic particle, magnetic particle, silica, glass fiber, polymer filters, cellulose fibers or hydrogels.

The liquid can be aqueous, non-aqueous, polar, non-polar, aprotic, neutral pH, acidic pH or basic pH. In some examples, the liquid comprises a solvent such as, for example, a spray liquid employed in electrospray mass spectroscopy. In some examples, liquids include solvents, but are not limited to, polar organic compounds such as, e.g., alcohols (e.g., methanol, ethanol and propanol), acetonitrile, dichloromethane, dichloroethane, tetrahydrofuran, dimethylformamide, dimethylsulphoxide, and nitromethane; non-polar organic compounds such as, e.g., hexane, toluene, cyclohexane; and water, for example, or combinations of two or more thereof. Optionally, the solvents may contain one or more of an acid or a base as a modifier (such as, volatile salts and buffer, e.g., ammonium acetate, ammonium biocarbonate, volatile acids such as formic acid, acetic acids or trifluoroacetic acid, heptafluorobutyric acid, sodium dodecyl sulphate, ethylenediamine tetraacetic acid, and non-volatile salts or buffers such as, e.g., chlorides and phosphates of sodium and potassium.

In many examples, the above combination is provided in an aqueous medium, which may be solely water or which may also contain organic solvents such as, for example, polar aprotic solvents, polar protic solvents such as, e.g., dimethylsulfoxide (DMSO), dimethylformamide (DMF), acetonitrile, an organic acid, or an alcohol, and non-polar solvents miscible with water such as, e.g., dioxane, in an amount of about 0.1% to about 50%, or about 1% to about 50%, or about 5% to about 50%, or about 1% to about 40%, or about 1% to about 30%, or about 1% to about 20%, or about 1% to about 10%, or about 5% to about 40%, or about 5% to about 30%, or about 5% to about 20%, or about 5% to about 10%, by volume. In some examples, the pH for the aqueous medium is usually a moderate pH. In some examples the pH of the aqueous medium is about 5 to about 8, or about 6 to about 8, or about 7 to about 8, or about 5 to about 7, or about 6 to about 7, or physiological pH, for example. Various buffers may be used to achieve the desired pH and maintain the pH during any incubation period. Illustrative buffers include, but are not limited to, borate, phosphate (e.g., phosphate buffered saline), carbonate, TRIS, barbital, PIPES, HEPES, MES, ACES, MOPS, and BICINE.

The amount of aqueous medium employed is dependent on a number of factors such as, but not limited to, the nature and amount of the sample, the nature and amount of the reagents, the stability of target rare cells, and the stability of target rare molecules. In some examples in accordance with the principles described herein, the amount of aqueous medium per 10 mL of sample is about 5 mL to about 100 mL, or about 5 mL to about 80 mL, or about 5 mL to about 60 mL, or about 5 mL to about 50 mL, or about 5 mL to about 30 mL, or about 5 mL to about 20 mL, or about 5 mL to about 10 mL, or about 10 mL to about 100 mL, or about 10 mL to about 80 mL, or about 10 mL to about 60 mL, or about 10 mL to about 50 mL, or about 10 mL to about 30 mL, or about 10 mL to about 20 mL, or about 20 mL to about 100 mL, or about 20 mL to about 80 mL, or about 20 mL to about 60 mL, or about 20 mL to about 50 mL, or about 20 mL to about 30 mL.

The phrase “cell culture medium” refers to a liquid or gel medium that contains components that support the growth and/or cultivation of cells under controlled conditions. The cell culture medium may be a complete formulation that requires no supplementation to culture cells or it may be an incomplete formulation that requires supplementation. Although the components may differ based on the particular type of cell to be grown, most cell culture media are basal aqueous media and contain a mixture of nutrients dissolved in a buffered solution such as buffered physiological saline. Examples of cell culture medium include, but are not limited to, Medium 199 (M199), Ham's media (Ham's F-12), Dulbecco's modified Eagle's medium (DMEM), Roswell Park Memorial Institute (RPMI) media, Lewis, modified Eagle's medium (MEM), MCDB, basal medium eagle (BME), hypoxanthine-aminopterin-thymidine medium (HAT), serum free media, Iscove's Modified Dulbecco's Media, and IMDM Hank's balanced salt solution without calcium (HBSS).

Components of the cell culture medium may be supplemented with nutrients such as, but not limited to, amino acids, lipids vitamins, co-factors, buffers, antioxidants, proteins and energy sources, for example heparin, choline, glutamine, sodium pyruvate, thymine, biotin, folic acid, amino acids, lecithin, albumin, transferrin, linoleic acid, epinephrine, transferrin, and triiodothyronine, inorganic and metal salts such as, but not limited to, salts of ammonium, calcium, cupric, ferrous, magnesium, molybdic, potassium, nickel, magnesium, zinc, sodium, selenium, and stannous, one or more sugars such as, but not limited to, glucose and dextrose, for example; antibiotics such as, but not limited to, gentamicin, amphotericin, penicillin, streptomycin, amphotericin B, bactopeptone, mercaptoethanol, isoperterenol, and cholera toxin, adhesion factors such as, but not limited to, gelatin, collagen, fibronectin, and vitogen, for example; reducing agents such as, but not limited to, thiols, phosphoethanol amine, and ethanolamine, growth factors such as, but not limited to, insulin, epidermal growth factor (EGF), fibroblast growth factor (FGF), growth hormone (GH) estrogen, insulin-like growth factor (IGF), placental growth factor (PDF), hepatocyte growth factor (HGF), nerve growth factor (NGF), hypoxia inducible factor (HIF), platelet-derived growth factor (PDGF), and growth differentiation factors (GDF), and hydrocortisone, blood serum from a mammal containing growth factors such as, but not limited to, human serum, cow serum, calf serum, horse serum, pig serum, platelet lysate, pituitary extracts, heat-inactivated serum, and fetal serum, cytokines such as, but not limited to, cytokine-induced neutrophil chemoattractant, monocyte chemotactic protein, macrophage inflammatory protein, macrophage inhibitory cytokine, nuclear factor kappa-light-chain-enhancer of activated B cells, calgranulin, transforming growth factor, tumor necrosis factors, interleukin cytokines, lipocalin, peptidases, proteases and inhibitors of, e.g., trypsin, elastase, cathepsin, tryptase, trypsin, kallikrein, thrombin, plasmin, factors III, V, VII & X, proteinase, trypsin inhibitors, bikunin, uristatin, tissue factor pathway inhibitor, and matrix metalloproteinase. Many cell culture media are commercially available.

The amounts of the components of the cell culture medium are dependent on the nature of the rare cells to be grown, the type of sample, the non-rare cells not to be grown, the nature of surface the cells are grown on, and the surface of cells. In general, the amount of insulin in a cell culture medium is about 0.01 to about 10 μM, or about 0.1 to about 10 μM, or about 1 to about 10 μM, or about 1 to about 5 μM.

The pH for the cell culture medium is about 7.0 to about 7.7. Various buffers may be used to achieve the desired pH and maintain the pH during any incubation period. Illustrative buffers include, but are not limited to, borate, bicarbonate, phosphate (e.g., phosphate buffered saline), carbonate, TRIS, barbital, PIPES, HEPES, MES, ACES, MOPS, and BICINE.

Conditions for culturing a cell vary based on the nature of the cell, the nature of the medium, the nature of the cell incubator, cell-cell interactions, diffusion of gases, interactions of cells with the matrix, osmotic pressure, pH, O₂ and CO₂ tension, and the species of the animal. Most human and mammalian cell lines are maintained at 36° C. to 37° C. for optimal growth. The temperature for cell culture is about 20° C. to about 60° C., or about 30° C. to about 50° C., or about 30° C. to about 40° C., or about 36° C. to about 37° C., or about 35° C. to about 38° C., or about 32° C. to about 39° C., for example. Cells are usually cultured in the presence of a gas, the amount of which is related to the nature of the gas, the nature of the cells, and the nature of a cell incubator, for example. The amount of gas employed is about 96% to about 1% volume/weight of total air. Gases employed in cell culture include, but are not limited to carbon dioxide, nitrogen, oxygen, and noble gases, for example, and mixtures thereof. Normoxia in a cell culture is 78% nitrogen 21% oxygen and 1% noble gases and carbon dioxide. The amount of carbon dioxide employed is about 4% to about 10% volume/weight total air.

### Examples of Microfluidic Surface

In accordance with the present invention, liquid is added to the top portion of a porous matrix and moves through the porous matrix to the liquid volume area in the microfluidic surface. The “liquid droplet” held in liquid volume area is moved by application of hydrodynamic force from the microfluidic surface through at least one exit hole. The hydrodynamic force generator allows variation of strengths and times of the hydrodynamic force applied. The hydrodynamic forces can be adjusted to overcome the resistance for moving the liquid through the porous matrix and microfluidic surface.

The microfluidic surface exit can be a restrictive structure acting as a stop function and requiring a greater hydrodynamic force to move liquid through the exit hole than the porous matrix. The microfluidic surface can have structures like planes, and cones that do not trapp liquid, but rather help gather liquids to a central point for the liquids droplet exit. The microfluidic surface can have droplet inducing feature around the exit that help to gather the droplet, and prevent liquid loss by spreading on the outer surface. The microfluidic surface can have more than one exit provided the additional exits allow liquids to completely exit the surface in a central location. The volume of liquid expelled through one or more exit hole is dependent on the volume of the spray liquid samples, the size of the exit hole, nature of liquid, size of the liquid volume area, the shape of the liquid volume area, the surface or the liquid volume area, the number of exit holes, the pattern of exit holes, the restrictive structures of the microfluidic surface, the number of liquid areas in an array, the hydrodynamic force, the number of exit holes, the exit hole size, the exit hole angle, and the rigidity of the microfluidic surface and the hydrophobicity of the microfluidic surface.

In accordance with the invention, the exit hole in the microfluidic surface can also have an intrinsic surface feature or a droplet-inducing feature used to move the desired liquid droplet completely from the exit hole to the liquid receiving area. In some examples, the volume of liquid expelled is about 10 nL to about 1 μL, or about 10 nL to about 1 μL, to about 10 μL, or to about 100 μL, or to about 1000 μL.

When the hydrodynamic force generator is an electric field, charged liquid droplets and solvated ions are moved to the entrance of a mass spectrometer or capillary as the sample receiving area. A spray of analyte-bearing ions from the liquid volume area occurs by charged droplet field emission. A combination of pneumatic and electrostatic forces may be employed to collect ions for subsequent analysis by a mass spectrometer. This includes cases in which pneumatic forces are provided either by suction from a mass spectrometer inlet or by gas flow provided, independent of a mass spectrometer.

The liquid volume area can be of any shape, structure or geometry and can contain capillaries and wells enabled to conduct microfluidic operations such as mixing with other liquids, splitting and segmentation. In some examples, liquids can be added before or after the addition of sample to the area. In some example the area has one entrance and one exit opening or in other examples can have multiple entrance and exit opening for liquids, air and/or vacuums.

In some examples, reagents can be in the liquid or dried in the area. In some examples, the liquids in the area do not completely fill the area to allow open air during mixing and dilution. The microfluidic surface can be made of glass, metals or molded plastics such as thermoplastics, like polystyrene, polyethylenes, thermosets, elastomers or other non-porous materials such as those used for the liquid areas and holders. The microfluidic surface has at least one liquid volume area per porous matrix. The liquid volume area has at least one exit hole. The liquid volume area is directly below some portion of porous matrix or partial below and adjacent to the porous matrix and is able of holding from 1 nL to 1000 μL of liquid.

The apparatus has a point of contact between the holder for the removable porous matrix and the microfluidic surface which do not obstruct the flow of liquid through the porous matrix but are complete contacts at the edges of the porous matrix such that liquid does not exit from between the holder surface and the microfluidic surface. Complete contact can be accomplished by mechanical fit, adhesion or compression using materials as described above. This complete contact is not permanent and the surfaces can be detached. This point of contact is dependent on the shape of the porous matrix and the sample of the microfluidic surface.

The apparatus has a microfluidic surface with liquid volume area that can extend into a position such that it is at any angle from the center of porous matrix. The shape of the liquid volume area can be a cylinder, oval, rectangular, polygon, cube or capillary. The liquid volume area has an exit hole that intersects the surface of microfluidic which can have a droplet-inducing feature. The microfluidic surface has at least one exit hole per porous matrix connected to each liquid volume area, in a position such that it is below or adjacent to the porous matrix and at any angle from the surface of the porous matrix. The shape of the exit can be a cylinder, polygon, cube or capillary and the size can be equal, smaller or greater than the volume area dependent on the spray liquid, the volume to be sprayed, the nature of the hydrodynamic force generator, the size of the porous matrix and the portion of the porous matrix in contact with the liquid volume area.

In some examples, the exit hole might have a droplet-inducing feature, such as a structure at the intersection of an outer surface and inner microfluidic surface such as, but not limited to, a protrusion that extends from a surface, or a capillary or channel which extend to the liquid volume area. A droplet-inducing feature may be circular, oval, rectangular or any shape increasing droplet formation. In some examples the intersection of the exit through the microfluidic surfaces is at an angle of about 30° to about 150°, or about 30° to about 125°, or about 30° to about 110°, or about 30° to about 100°, or about 30° to about 95°, or about 30° to about 90°, or about 45° to about 150°, or about 60° to about 150°, or about 75° to about 150°, or about 80° to about 150°, or about 85° to about 150°, or about 90° to about 150°, or about 45° to about 125°, or about 60° to about 110°, or about 70° to about 100°, or about 80° to about 100°, or about 85° to about 95°, or about 90°, for example.

### Example of Hydrodynamic Force Generators

In some examples in accordance with the invention, a hydrodynamic force is applied to liquids on the porous matrix so liquids can be moved through the microfluidic surface to the liquid receiving area as a liquid droplet. The hydrodynamic force can be generated by capillary action, air pressure, vacuum, centrifugal force or the generation of an electric field. In some examples, the porous matrix is removed before the hydrodynamic force is applied. In some examples, the porous matrix is placed on top of the microfluidic surface before the hydrodynamic force is applied. In some examples, the porous matrix is placed on top of a microfluidic surface and the microfluidic surface can be placed on the liquid receiving area before the hydrodynamic force is applied. In some examples, holders or gaskets are used. In some cases, the microfluidic surface is placed in a mass spectrometer. The nature and intensity of the hydrodynamic field is dependent on one or more of the following: the nature of the liquid, the exit hole pore size, the amount of liquid, the distance between the microfluidic surface and the hydrodynamic field generator, the distance between the microfluidic surface and the liquid receiving area, and the potentials applied to the electric field generator. In some cases the electrical potential is supplied continuously via a high voltage source in order to generate a continuous spray from the porous matrix.

In some examples the hydrodynamic force genertaor is placed on the porous matrix from the liquid holding areas, or to the liquid volume area through the microfluidic structure. In some examples the hydrodynamic force generator is disposed for movement to different liquid area. In some examples, the hydrodynamic force generator, or the liquid area are attached to a mechanism that is capable of movement to bring the hydrodynamic force generator into disposition with respect to specific liquid area to selectively induce liquid droplet removal from a liquid holding areas which is part of an array of liquid holding areas. In other examples, the hydrodynamic force generator is directed selectively to different regions of an array of liquid area.

As mentioned above, during mass spectroscopic analysis there is a spray emitted from exit holes of a microfluidic surface that is accomplished by the generation of an electric field in the vicinity of the microfluidic surface. The spray emission contains charged droplets of spray liquid, analyte, analyte ions or analytical labels. The electric field is established by providing an electrical potential of about 1 kilovolt (kV) to about 10 kilovolts (kV), or about 1 kV to about 5 15 kV, or about 2 kV to about 10 kV, or about 5 kV to about 10 kV, or about 6.0 to 6.5 kV to a conductive element (hereafter referred to as the electric field generator) located 0.05 mm up to 20 mm distant from the top side of the microfluidic surface while the bottom side of the microfluidic surface exit is held a distance of 0.01 mm to 5 mm from the inlet capillary of a mass spectrometer, which is held at a potential of −300 V up to +300 V. In other cases, the electrical potential is supplied by compressing or decompressing a piezo-electric device (such as an anti-static gun) that is connected to the electric field generator. Furthermore, discrete emission of charged droplets and analytes from the porous matrix may be accomplished by providing one, or a series of electrical pulses in the range of 1 kV to about 15 kV, to the electric field generator for a duration from as little as 0.5 ms per individual pulse to as much as 2 minutes per individual pulse.

In other examples, an electric field generator is disposed essentially in the porous matrix, a cover surface, the microfluidic surface or the holder surface where conductive materials are activated to produce an electric field generator. In some examples, the hydrodynamic force generator is an integral electrical grid line. In some examples, the hydrodynamic force generator is a separate electrical grid and is activated upon movement of microfluidic surface to position the exit hole over mass spectroscopy inlet hold.

In some examples, the electric field generator is a line, a plate, an ion stream or combinations thereof. Application of, for example, an electrical potential, to the hydrodynamic force generator results in activation of the hydrodynamic force generator. An ion stream may be produced by different means including, but not limited to the generation of a plasma by dielectric barrier discharge, the application of an alternating electrical potential to a suitable conductive element, the application of a static electrical potential to a suitable conductive element, or the compression of a piezoelectric material which is connected to a suitable conductive element. In each case, the suitable conductive element is composed of an electrical conductive material of suitable geometry such that the electric field strength (upon application of electrical potential) is of sufficient magnitude to cause electrical breakdown of the surrounding medium.

### Examples of Analytical Labels

In accordance with the invention, analytical labels are employed for detection and measurement of different populations of rare molecules. Analytical labels are molecules, metals, charges, ions, atoms or electrons that are detectable using analytical methods to yield information about the presence and amounts of rare molecules over other molecules in the sample. The principles described herein are directed to methods using analytical labels for detecting one or more different populations of target rare molecules in a sample suspected of containing the one or more different populations of rare molecules and non-rare molecules. In some examples, the rare molecules are in a cell. In other examples, the rare molecules are free of cells or “cell free” assays. In other examples, the rare molecules are cells or “rare cell assay”.

In some in accordance with the principles described herein, the concentration of one or more different populations of rare molecules is retained on the porous matrix and reacted with an analytical label precursor to generate and release an analytical label from the porous matrix. The analytical labels can be detected when retained on the porous matrix or released from the membrane into analysis liquid. In some examples, the analytical labels are released from analytical label precursor into the analysis liquid without the rare molecule. In other examples, the analytical labels are released from analytical label precursor into the analysis liquid with the rare molecule. In other examples, the analytical labels are not released from analytical label precursor into the analysis liquid with the rare molecule.

The porous matrix or analysis liquid are subjected to analysis to determine the presence and/or amount of each different analytical label. The presence and/or amount of each different analytical label are related to the presence and/or amount of each different population of target rare molecules in the sample. The analytical labels can be analytical labels that can be measured by optical, electrochemical, or mass spectrographic methods as optical analytical labels, electrochemical analytical labels or mass spectrometry analytical labels. Optional presence and/or amount of each different types of labels whether optical analytical labels, electrochemical analytical labels or mass spectrometry analytical labels can be related to each other to determine the presence and/or amount of each different population of target rare molecules retained on the porous substrate or released into the analysis liquid.

In some examples, the analysis liquid with analytical labels can go in to a liquid receiving area that is sampled by an analyzer. In other examples, the analysis liquid with analytical labels can be retained on the porous matrix that is sampled by an analyzer. In another case, the liquid receiving area can be inside an analyzer and the analysis liquid with analytical labels can go directly into an analyzer. In some analysis examples, the porous matrix is removed and placed in analyzer either on top and/or bottom and placed in a analyzer or reader where analytical labels analyzed and converted to information about one or both of the presence and different amount of each.

In an alternate embodiment, analytical labels are released from analytical label precursor. In many examples, analytical labels can be generated after reaction with a chemical to break a bond. In other examples, analytical labels are generated from analytical label precursor substrate which are derivatives that undergo reaction with an enzyme such as horseradish peroxidase, alkaline phosphatase, β-galactosidase, flavo-oxidase enzyme, urease or methyltransferase to name a few, to release the label. In other examples, the analytical labels can be generated after reaction with an electron or ion, such as an electro-chemiluminescence (ECL) label.

As mentioned above, one or more linking groups may comprise a cleavable moiety that is cleavable by a cleavage agent. The nature of the cleavage agent is dependent on the nature of the cleavable moiety. Cleavage of the cleavable moiety may be achieved by chemical or physical methods, involving one or more of oxidation, reduction, solvolysis, e.g., hydrolysis, photolysis, thermolysis, electrolysis, sonication, and chemical substitution, for example. Examples of cleavable moieties and corresponding cleavage agents, by way of illustration and not limitation, include disulfide that may be cleaved using a reducing agent, e.g., a thiol; diols that may be cleaved using an oxidation agent, e.g., periodate; diketones that may be cleaved by permanganate or osmium tetroxide; diazo linkages or oxime linkages that may be cleaved with hydrosulfite; β-sulfones, which may be cleaved under basic conditions; tetralkylammonium, trialkylsulfonium, tetralkylphosphonium, where the α-carbon is activated, e.g., with carbonyl or nitro, that may be cleaved with base; ester and thioester linkages that may be cleaved using a hydrolysis agent such as, e.g., hydroxylamine, ammonia or trialkylamine (e.g., trimethylamine or triethylamine) under alkaline conditions; quinones where elimination occurs with reduction; substituted benzyl ethers that can be cleaved photolytically; carbonates that can be cleaved thermally; metal chelates where the ligands can be displaced with a higher affinity ligand; thioethers that may be cleaved with singlet oxygen; hydrazone linkages that are cleavable under acidic conditions; quaternary ammonium salts (cleavable by, e.g., aqueous sodium hydroxide); trifluoroacetic acid-cleavable moieties such as, e.g., benzyl alcohol derivatives, teicoplanin aglycone, acetals and thioacetals; thioethers that may be cleaved using, e.g., HF or cresol; sulfonyls (cleavable by, e.g., trifluoromethane sulfonic acid, trifluoroacetic acid, or thioanisole); nucleophile-cleavable sites such as phthalamide (cleavable, e.g., with substituted hydrazines); ionic association (attraction of oppositely charged moieties) where cleavage may be realized by changing the ionic strength of the medium, adding a disruptive ionic substance, lowering or raising the pH, adding a surfactant, sonication, and adding charged chemicals; and photocleavalbe bonds that are cleavable with light having an appropriate wavelength such as, e.g., UV light at 300 nm or greater.

In one example, a cleavable linkage may be formed using conjugation with N-succinimidyl 3-(2-pyridyldithio)propionate) (SPDP), which comprises a disulfide bond. For example, a label particle comprising an amine functionality is conjugated to SPDP and the resulting conjugate can then be reacted with a analytical label comprising a thiol functionality, which results in the linkage of the MS label moiety to the conjugate. A disulfide reducing agent (such as, for example, dithiothreitol (DTT) or tris(2-carboxyethyl)phosphine (TCEP)) may be employed as an alteration agent to release a thiolated peptide as an analytical label.

The phrase “optical analytical labels” refers to a group of molecules having illumination with light of a particular wavelength, such as: a chemiluminescent label like luminol, isoluminol, acridinium esters, adamantyl 1, 2-dioxetane aryl phosphate, metals derivatives of or others commonly available to researchers in the field; a fluorescent label like fluorescein, lanthanide metals, Hoechst 33258, R-phycocyanin, B-phycoerythrin, R-phycoerythrin, rhodamine, DyLight Dyes™, Texas red, metals or other list commonly available to researchers in the field (see http://www.fluorophores.org/) chromogenic label tetramethylbenzidine (TMB), particles, metals or others. Optical analytical labels are detectable by optical methods like microscope, camera, optical reader, colorimeter, fluorometer, luminometer, reflectrometer, and others.

The phrase “electrochemical analytical labels” refers to potentiometric, capacitive and redox active compounds such as: metals like Pt, Ag, Pd, Au and many others or; particles like gold sols, graphene oxides and many others or; electron transport molecules like ferrocene, ferrocyanide, Os(VI)bipy and many others or; electrochemical redox active molecules like aromatic alcohols and amines such as 4-aminophenyl phosphate, 2-naphthol, para-nitrophenol phosphate; thiols or disulfides such as those on aromatics, aliphatics, amino acids, peptides and proteins; aromatic heterocyclic containing non-carbon ring atoms, like, oxygen, nitrogen, or sulfur such as like imidazoles, indoles, quinolones, thiazole, benzofuran and many others. Electrochemical analytical labels are detectable by impedance, capacitance, amperometry, electrochemical impedance spectroscopy and other measurement.

The phrase “mass spectrometry labels” or “MS labels” refers to a group of molecules having unique masses below 3 kDA such that each unique mass, corresponds to, and is used to determine a presence and/or amount of, each different population of target rare molecules. The MS labels are molecules of defined mass and include, but are not limited to, polypeptides, polymers, fatty acids, carbohydrates, organic amines, nucleic acids, and organic alcohols, for example, whose mass can be varied by substitution and chain size. In the case of polymeric materials, the number of repeating units is adjusted such that the mass is in a region that does not overlap with a background mass from the sample. The MS label generates a unique mass pattern due to structure and fragmentation upon ionization.

The “MS label precursor” is any molecule that results in an MS label. The MS label precursor may through the action of the alteration agent be converted to another MS label by cleavage, by reaction with a moiety, by derivatization, or by addition or by subtraction of molecules, charges or atoms, for example, or a combination of two or more of the above.

The nature of the MS label precursors is dependent on one or more of the nature of the MS label, the nature of the MS method employed, the nature of the MS detector employed, the nature of the target rare molecules, the nature of the affinity agent, the nature of any immunoassay employed, the nature of the sample, the nature of any buffer employed and the nature of the separation. In some examples, the MS label precursors are molecules whose mass can be varied by substitution and/or chain size. The MS labels produced from the MS label precursors are molecules of defined mass, which should not be present in the sample to be analyzed. Furthermore, the MS labels should be in the range detected by the MS detector, should not have over-lapping masses and should be detectable by primary mass. Examples, by way of illustration and not limitation, of MS label precursors for use in methods in accordance with the principles described herein to produce MS labels include, by way of illustration and not limitation, polypeptides, organic and inorganic polymers, fatty acids, carbohydrates, cyclic hydrocarbons, aliphatic hydrocarbons, aromatic hydrocarbons, organic carboxylic acids, organic amines, nucleic acids, organic alcohols (e.g., alkyl alcohols, acyl alcohols, phenols, polyols (e.g., glycols), thiols, epoxides, primary, secondary and tertiary amines, indoles, tertiary and quaternary ammonium compounds, amino alcohols, amino thiols, phenolic amines, indole carboxylic acids, phenolic acids, vinylogous acid, carboxylic acid esters, phosphate esters, carboxylic acid amides, carboxylic acids from polyamides and polyesters, hydrazone, oxime, trimethylsilyl enol ether, acetal, ketal, carbamates, ureas, guanidines, isocyanates, sulfonic acids, sulfonamides, sulfonylureas, sulfates esters, monoglycerides, glycerol ethers, sphingosine bases, ceramines, cerebrosides, steroids, prostaglandins, carbohydrates, nucleosides and therapeutic drugs.

An MS label precursor can include 1 to about 100,000 MS labels, or about 10 to about 100,000 MS labels, or about 100 to about 100,000 MS labels, or about 1,000 to about 100,000 MS labels, or about 10,000 to about 100,000 MS labels, for example. The MS label precursor can be comprised of proteins, polypeptides, polymers, particles, carbohydrates, nucleic acids, lipids or other macromolecules capable of including multiple repeating units of MS labels by attachment. Multiple MS labels allow amplification as every MS label precursor can generate many MS labels.

Examples of small molecule peptides, which may function also as MS labels, include, by way of illustration and not limitation, peptides that comprise two or more of histidine, lysine, phenylalanine, leucine, alanine, methionine, asparagine, glutamine, aspartic acid, glutamic acid, tryptophan, proline, valine, tyrosine, glycine, threonine, serine, arginine, cysteine and isoleucine and derivatives thereof. In some examples, the peptides have a molecular weight of about 100 to about 3,000 mass units and may contain 3 to 30 amino acids. In some examples, the peptides comprise nine amino acids selected from the group consisting of tyrosine, glycine, methionine, threonine, serine, arginine, phenylalanine, cysteine and isoleucine and have masses of 1,021.2; 1,031.2; 1,033.2; 1,077.3; 1,087.3; 1,127.3; 1,137 mass units; or 3 amino acids from the above group and having masses of 335.4, 433.3, 390.5, 426.5, and 405.5 mass units. The number of amino acids in the peptide is determined by, for example, the nature of the MS technique employed. For example, when using MALDI for detection, the peptide can have a mass in the range of about 600 to about 3,000 and is constructed of about 6 to about 30 amino acids. Alternatively, when using EIS for detection, the peptide has a mass in the range of about 100 to about 1,000 and is constructed of 1 to 9 amino acids or derivatives of, for example. In some examples, the number of amino acids in the peptide label may be 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30, for example.

The use of peptides as MS labels has several advantages, which include, but are not limited to, the following: 1) relative ease of conjugation to proteins, antibodies, particles and other biochemical entities; 2) relative ease with which the mass can be altered to allow many different masses thus providing for multiplexed assay formats and standards; and 3) adjustability of the mass to a mass spectrometer used. For conjugation, the peptides can have a terminal cysteine that is employed in the conjugation. For ionization, the peptides can have charged amine groups. In some examples, the amino acid peptides have N-terminal free amine and C-terminal free acid. In some examples, the amino acid peptides are isotope labeled or derivatized with an isotope. The peptides may be conjugated to a small molecule such as, for example, biotin or fluorescein, for binding to a corresponding binding partner for the small molecule, which in this example is streptavidin or antibody for fluorescein. Biotin or fluorescein may be conjugated at the N-terminal with the C-terminal being free acid.

With polypeptide MS label precursors, for example, the chain length of the polypeptide can be adjusted to yield an MS label in a mass region without background peaks. Furthermore, MS labels may be produced from the MS label precursors having unique masses, which are not present in the sample tested. The polypeptide MS label precursors can comprise additional amino acids or derivatized amino acids, which allows methods in accordance with the principles described herein to be multiplexed to obtain more than one result at a time. Examples of polypeptide MS label precursors include, but are not limited to, polyglycine, polyalanine, polyserine, polythreonine, polycysteine, polyvaline, polyleucine, polyisoleucine, poly-methionine, polyproline, polyphenylalanine, polytyrosine, polytryptophan, polyaspartic acid, polyglutamic acid, polyasparagine, polyglutamine, polyhistidine, polylysine and polyarginine. Polypeptide MS label precursors differentiated by mixtures of amino acids or derivatized amino acids generate masses having even or odd election ion with or without radicals. In some examples, polypeptides are able to be modified by catalysis. For example, by way of illustration and not limitation, phenol and aromatic amines can be added to polythreonine using a peroxidase enzyme as a catalyst. In another example, by way of illustration and not limitation, electrons can be transferred to aromatic amines using peroxidase enzyme as a catalyst. In another example, by way of illustration and not limitation, phosphates can be removed from organic phosphates using phosphatases as a catalyst.

In another example, by way of illustration and not limitation, a derivatization agent is employed as a moiety to generate an MS label from an MS label precursor. For example, dinitrophenyl and other nitrophenyl derivatives may be formed from the MS label precursor. Other examples include, by way of illustration and not limitation, esterification, acylation, silylation, protective alkylation, derivatization by ketone-base condensations such as Schiff bases, cyclization, formation of fluorescent derivatives, and inorganic anions. The derivatization reactions can occur in microreaction prior to MS analysis but after affinity reaction or be used to generate MS label precursors conjugated to affinity reagents.

In some examples, the MS label precursor can comprise an isotope such as, but not limited to, ²H, ¹³C, and ¹⁸O, for example, which remains in the MS label that is derived from the MS label precursor. The MS label can be detected by the primary mass or a secondary mass after ionization. In some examples, the MS label precursor is one that has a relatively high potential to cause a bond cleavage such as, but not limited to, alkylated amines, acetals, primary amines and amides, where the MS label can generate a mass that has even or odd election ion with or without radicals. Selection of the polypeptide can generate a unique MS spectral signature.

Internal standards are an important aspect of mass spectral analysis. In some examples, a second mass label can be added that can be measured (as an internal standard) in addition to the MS label used for detection of the rare target molecule. The internal standard has a similar structure to the MS label with a slight shift in mass. The internal standards can be prepared that comprise additional amino acids or derivatized amino acids. Alternatively, the internal standard can be prepared by incorporating an isotopic label such as, but not limited to ²H (D), ¹³C, and ¹⁸O, for example. The MS isotope label has a mass higher than the naturally-occurring substance. For example, the isotope labeled MS labels, for example, glycerol-C-d7, sodium acetate-C-d7, sodium pyruvate-C-d7, D-glucose-C-d7, deuterated glucose, and dextrose-C-d7, would serve as internal standards for glycerol, sodium acetate, sodium pyruvate, glucose and dextrose, respectively.

MS analysis determines the mass-to-charge ratio (m/z) of molecules for accurate identification and measurement. The MS method ionizes molecules into masses as particles by several techniques that include, but are not limited to, matrix-assisted laser desorption ionization (MALDI), atmospheric pressure chemical ionization (APCI), electrospray ionization (ESI), inductive electrospray ionization (iESI), chemical ionization (CI), and electron ionization (EI), fast atom bombardment (FAB), field desorption/field ionization (FC/FI), thermospray ionization (TSP), nanospray ionization, for example. The masses are filtered and separated in the mass detector by several techniques that include, by way of illustration and not limitation, Time-of-Flight (TOF), ion traps, quadrupole mass filters, sector mass analysis, multiple reaction monitoring (MRM), and Fourier transform ion cyclotron resonance (FTICR). The MS method detects the molecules using, for example, a microchannel plate, electron multiplier, or Faraday cup. The MS method can be repeated as a tandem MS/MS method, in which charged mass particles from a first MS are separated into a second MS. Pre-processing steps for separating molecules of interest, such as, by way of example, ambient ionization, liquid chromatography (LC), gas chromatography (GC), and affinity separation, can be used prior to the MS method.

Mass analyzers include, but are not limited to, quadrupoles, time-of-flight (TOF) analyzers, magnetic sectors, Fourier transform ion traps, and quadrupole ion traps, for example. Tandem (MS-MS) mass spectrometers are instruments that have more than one analyzer. Tandem mass spectrometers include, but are not limited to, quadrupole-quadrupole, magnetic sector-quadrupole, quadrupole-time-of-flight. The detector of the mass spectrometer may be, by way of illustration and not limitation, a photomultiplier, an electron multiplier, or a micro-channel plate, for example.

Following the analysis by mass spectrometry, the presence and/or amount of each different mass spectrometry label is related to the present and/or amount of each different population of target rare cells and/or the particle-bound target rare molecules. The relationship between the MS label and a target molecule is established by the modified affinity agent employed, which is specific for the target molecule. Calibrators are employed to establish a relationship between an amount of signal from an MS label and an amount of target rare molecules in the sample. Furthermore, selection of the MS label may be carried out to avoid overlapping masses in the analysis, to avoid background interference in the MS analysis, and to permit multiplexing

### Examples of Cover Surfaces

In some examples the porous matrix or liquid area is associated with a cover surface in direct contact with the porous matrix or liquids in the liquid areas. The cover surface can be an associated feature needed for analysis of analytical labels. The cover surface can be electrodes, sensors, electric field generators, hydrodynamic force generators and optical protective surfaces needed for analysis, release of analytical label or for generation of hydrodynamic force. The cover surface can be associated with the top or bottom or top side surface porous matrix or liquid area. In some analysis examples, the porous matrix is removed and covered surfaces on top and/or bottom are placed in a microscope or reader where fluorescent signals analyzed and converted to information about one or both of the presence and different amount of each.

The cover surface can be generally part of the apparatus where the porous matrix or liquid is used for microscopic, electrochemical, optical, fluorescent or mass spectroscopic analysis or sample collection. The cover surfaces can contain or lack pores or have a surface which facilitates contact with associated surfaces that are not permanently attached to these surfaces and can be removed or is permanently attached. The cover surfaces can be made of glass, plastic films or molded plastics as described above for holders. The cover surfaces can be made of square, oval, circular, rectangular, or other shapes.

The cover surfaces are placed on the opposing surface of the porous matrix such that liquid evaporation is prevented and liquid in the liquid areas is contained. Cover surface can cover one or more porous matrix and contact only the holder or both holder and porous matrix. Additional liquids like spray liquids or others can be added to the porous matrix before attachment of the cover and microfluidic surface for mass spectroscopic analysis. Additional liquids can be added to the porous matrix before the attachment covers for microscopic analysis. Additional liquids like dilution buffers and reagents can be added to the porous matrix before attachment covers for sample collection.

The cover surfaces used for microscopic or optical analysis can be transparent and thin materials, generally a fraction of millimeter (mm), for example 0.17 mm, to several millimeter similar to glass slides, for example 1.0 mm. The cover surface can be flat within micron tolerance across the porous matrix area.

### Examples of Rare Molecules and Rare Cells

The sample to be analyzed is one that is suspected of containing target rare molecules, non-rare cells and rare cells. The samples may be biological samples or non-biological samples. Biological samples may be from a mammalian subject or a non-mammalian subject. Mammalian subjects may be, e.g., humans or other animal species. Biological samples include biological fluids such as whole blood, serum, plasma, sputum, lymphatic fluid, semen, vaginal mucus, feces, urine, spinal fluid, saliva, stool, cerebral spinal fluid, tears, and mucus, for example. Biological tissue includes, by way of illustration, hair, skin, sections or excised tissues from organs or other body parts, for example. In many instances, the sample is whole blood, plasma or serum. Rare cells may be from, for example, lung, bronchus, colon, rectum, pancreas, prostate, breast, liver, bile duct, bladder, ovary, brain, central nervous system, kidney, pelvis, uterine corpus, oral cavity or pharynx or melanoma cancers. The rare cells may be, but are not limited to, pathogens such as bacteria, virus, fungus, and protozoa; malignant cells such as malignant neoplasms or cancer cells; circulating endothelial cells; circulating tumor cells; circulating cancer stem cells; circulating cancer mesochymal cells; circulating epithelial cells; fetal cells; immune cells (B cells, T cells, macrophages, NK cells, monocytes); and stem cells; for example. In some examples of methods in accordance with the principles described herein, the sample to be tested is a blood sample from a mammal such as, but not limited to, a human subject, for example. The blood sample is one that contains cells such as, for example, non-rare cells and rare cells. In some examples the blood sample is whole blood or plasma.

The phrase “target rare molecule” refers to a molecule including biomarkers that may be detected in a sample where the molecule or biomarker is indicative of a particular population of cells. Target rare molecules include, but are not limited to, antigens (such as, for example, proteins, peptides, hormones, vitamins, allergens, autoimmune antigens, carbohydrates, lipids, glycoproteins, co-factors, antibodies, and enzymes) and nucleic acids.

The phrase “population of target rare molecules” refers to a group of molecules that share a common antigen or nucleic acid that is specific for the group of molecules. The phrase “specific for” means that the common antigen or nucleic acid distinguishes the group of molecules from other molecules.

The phrase “population of cells” refers to a group of cells having an antigen or nucleic acid on their surface or inside the cell where the antigen is common to all of the cells of the group and where the antigen is specific for the group of cells.

Rare cells are those cells that are present in a sample in relatively small quantities when compared to the amount of non-rare cells in a sample. In some examples, the rare cells are present in an amount of about 10⁻⁸% to about 10⁻²% by weight of a total cell population in a sample suspected of containing the rare cells. The rare cells may be, but are not limited to, malignant cells such as malignant neoplasms or cancer cells; circulating endothelial cells; circulating epithelial cells; mesochymal cells; fetal cells; immune cells (B cells, T cells, macrophages, NK cells, monocytes); stem cells; nucleated red blood cells (normoblasts or erythroblasts); and immature granulocytes; for example. Rare cells can be organized as tissues and organoids, such as islets, vascular tissues, liver tissues, kidney tissues, brain tissues, fat tissues, pancreas tissues, tumors, muscle, heart, and any other tissue of an organism.

Non-rare cells are those cells that are present in relatively large amounts when compared to the amount of rare cells in a sample. In some examples, the non-rare cells are at least about 10 times, or at least about 10² times, or at least about 10³ times, or at least about 10⁴ times, or at least about 10⁵ times, or at least about 10⁶ times, or at least about 10⁷ times, or at least about 10⁸ times greater than the amount of the rare cells in the total cell population in a sample suspected of containing non-rare cells and rare cells. The non-rare cells may be, but are not limited to, white blood cells, platelets, and red blood cells, for example.

Target rare molecules of rare cells include, but are not limited to, cancer cell type biomarkers, oncoproteins and oncogenes, chemo resistance biomarkers, metastatic potential biomarkers, and cell typing markers, for example. Cancer cell type biomarkers include, by way of illustration and not limitation, cytokeratins (CK) (CK1, CK2, CK3, CK4, CK5, CK6, CK7, CK8 and CK9, CK10, CK12, CK 13, CK14, CK16, CK17, CK18, CK19, CK20 and CK2), epithelial cell adhesion molecule (EpCAM), N-cadherin, E-cadherin and vimentin, for example. Oncoproteins and oncogenes with likely therapeutic relevance due to mutations include, but are not limited to, WAF, BAX-1, PDGF, JAGGED 1, NOTCH, VEGF, VEGHR, CA1X, MIB1, MDM, PR, ER, SELS, SEM1, PI3K, AKT2, TWIST1, EML-4, DRAFF, C-MET, ABL1, EGFR, GNAS, MLH1, RET, MEK1, AKT1, ERBB2, HER2, HNF1A, MPL, SMAD4, ALK, ERBB4, HRAS, NOTCH1, SMARCB1, APC, FBXW7, IDH1, NPM1, SMO, ATM, FGFR1, JAK2, NRAS, SRC, BRAF, FGFR2, JAK3, RA, STK11, CDH1, FGFR3, KDR, PIK3CA, TP53, CDKN2A, FLT3, KIT, PTEN, VHL, CSF1R, GNA11, KRAS, PTPN11, DDR2, CTNNB1, GNAQ, MET, RB1, AKT1, BRAF, DDR2, MEK1, NRAS, FGFR1 and ROS1.

Endothelial cell typing markers include, by way of illustration and not limitation, CD136, CD105/Endoglin, CD144/VE-cadherin, CD145, CD34, Cd41 CD136, CD34, CD90, CD31/PECAM-1, ESAM, VEGFR2/Fik-1, Tie-2, CD202b/TEK, CD56/NCAM, CD73/VAP-2, claudin 5, Z0-1 and vimentin.

In methods in accordance with the invention, white blood cells may be excluded as non-rare cells. For example, markers such as, but not limited to, CD45, CTLA-4, CD4, CD6S and CDS that are present on white blood cells can be used to indicate that a cell is not a rare cell of interest. In a particular non-limiting example, CD45 antigen (also known as protein tyrosine phosphatase receptor type C or PTPRC) and originally called leukocyte common antigen is useful in detecting all white blood cells.

Additionally, CD45 can be used to differentiate different types of white blood cells that might be considered rare cells. For example, granulocytes are indicated by CD45+, CD15+; monocytes are indicated by CD45+, CD14+; T lymphocytes are indicated by CD45+, CD3+; T helper cells are indicated by CD45+, CD3+, CD4+; cytotoxic T cells are indicated by CD45+, CD3+, CDS+; β-lymphocytes are indicated by CD45+, CD19+ or CD45+, CD20+; thrombocytes are indicated by CD45+, CD61+; and natural killer cells are indicated by CD16+, CD56+, and CD3-. Furthermore, two commonly used CD molecules, namely, CD4 and CD8, are, in general, used as markers for helper and cytotoxic T cells, respectively. These molecules are defined in combination with CD3+, as some other leukocytes also express these CD molecules (some macrophages express low levels of CD4; dendritic cells express high levels of CDS).

Rare Cells of metabolic interest include but are not limited to WBC White blood cell, Tregs (regulatory T cells), B cell, macrophages, T cells, monocytes, antigen presenting cells (APC), dendritic cells, eosinophils, and granulocytes.

In other cases the rare cell is a pathogen, which includes, but is not limited to, gram-positive bacteria (e.g., Enterococcus sp. Group B streptococcus, Coagulase-negative staphylococcus sp. Streptococcus viridans, Staphylococcus aureus and saprophyicus, Lactobacillus and resistant strains thereof, for example); yeasts including, but not limited to, Candida albicans, for example; gram-negative bacteria such as, but not limited to, Escherichia coli, Klebsiella pneumoniae, Citrobacter koseri, Citrobacter freundii, Klebsiella oxytoca, Morganella morganii, Pseudomonas aeruginosa, Proteus mirabilis, Serratia marcescens, and Diphtheroids (gnb) and resistant strains thereof, for example; viruses such as, but not limited to, HIV, HPV, Flu, and MERSA, for example; and sexually transmitted diseases. In the case of detecting rare cell pathogens, a particle reagent is added that comprises a binding partner, which binds to the rare cell pathogen population. Additionally, for each population of cellular target rare molecules on the pathogen, a reagent is added that comprises a binding partner for the cellular target rare molecule, which binds to the cellular target rare molecules in the population.

The phrase “cell free target rare molecules” refers to target rare molecules that are not bound to a cell and/or that freely circulate in a sample. Such non-cellular target rare molecules include biomolecules useful in medical diagnosis of diseases, which include, but are not limited to biomarkers for detection of cancer, cardiac damage, cardiovascular disease, neurological disease, hemostasis/hemastasis, fetal maternal assessment, fertility, bone status, hormone levels, vitamins, allergies, autoimmune diseases, hypertension, kidney disease, diabetes, liver diseases, infectious diseases and other biomolecules useful in medical diagnosis of diseases.

Cell free target rare molecules of metabolic interest that are proteins include but are not limited to ACC Acetyl Coenzyme A Carboxylase, Adpn Adiponectin, AdipoR Adiponectin Receptor, AG Anhydroglucitol, AGE Advance glycation end products, Akt Protein kinase B, AMBK pre-alpha-1-microglobulin/bikunin, AMPK 5′-AMP activated protein kinase, ASP Acylation stimulating protein, Bik Bikunin, BNP B-type natriuretic peptide, CCL Chemokine (C—C motif) ligand, CINC Cytokine-induced neutrophil chemoattractant, CTF C-Terminal Fragment of Adiponectin Receptor, CRP C-reactive protein, DGAT Acyl CoA diacylglycerol transferase, DPP-IV Dipeptidyl peptidase-IV, EGF Epidermal growth factor, eNOS Endothelial NOS, EPO Erythropoietin, ET Endothelin, Erk Extracellular signal-regulated kinase, FABP Fatty acid-binding protein, FGF Fibroblast growth factor, FFA Free fatty acids, FXR Farnesoid X receptor a, GDF Growth differentiation factor, GH Growth hormone, GIP Glucose-dependent insulinotropic polypeptide, GLP Glucagon-like peptide-1, GSH Glutathione, GHSR Growth hormone secretagogue receptor, GULT Glucose transporters, GCD59 glycated CD59 (aka glyCD59), HbA1c Hemogloblin A1c, HDL High-density lipoprotein, HGF Hepatocyte growth factor, HIF Hypoxia-inducible factor, HMG 3-Hydroxy-3-methylglutaryl CoA reductase, I-α-I Inter-α-inhibitor, Ig-CTF Immunoglobulin attached C-Terminal Fragment of AdipoR, IDE Insulin-degrading enzyme, IGF Insulin-like growth factor, IGFBP IGF binding proteins, IL Interleukin cytokines, ICAM Intercellular adhesion molecule, JAK STAT Janus kinase/signal transducer and activator of transcription, JNK c-Jun N-terminal kinases, KIM Kidney injury molecule, LCN-2 Lipocalin, LDL Low-density lipoprotein, L-FABP Liver type fatty acid binding protein, LPS Lipopolysaccharide, Lp-PLA2 Lipoprotein-associated phospholipase A2, LXR Liver X receptors, LYVE Endothelial hyaluronan receptor, MAPK Mitogen-activated protein kinase, MCP Monocyte chemotactic protein, MDA Malondialdehyde, MIC Macrophage inhibitory cytokine, MIP Macrophage infammatory protein, MMP Matrix metalloproteinase, MPO Myeloperoxidase, mTOR Mammalian target of rapamycin, NADH Nicotinamide adenine dinucleotide, NGF Nerve growth factor, NFκB Nuclear factor kappa-light-chain-enhancer of activated B cells, NGAL Neutrophil gelatinase lipocalin, NOS Nitric oxide synthase NOX NADPH oxidase NPY Neuropeptide Yglucose, insulin, proinsulin, c peptide OHdG Hydroxydeoxyguanosine, oxLDL Oxidized low density lipoprotein, P-α-I pre-interleukin-α-inhibitor, PAI-1 Plasminogen activator inhibitor, PAR Protease-activated receptors, PDF Placental growth factor, PDGF Platelet-derived growth factor, PKA Protein kinase A, PKC Protein kinase C, PI3K Phosphatidylinositol 3-kinase, PLA2 Phosphatidylinositol 3-kinase, PLC Phospholipase C, PPAR Peroxisome proliferator-activated receptor, PPG Postprandial glucose, PS Phosphatidylserine, PR Protienase, PYY Neuropeptide like peptide Y, RAGE Receptors for AGE, ROS Reactive oxygen species, S100 Calgranulin, sCr Serum creatinine, SGLT2 Sodium-glucose transporter 2, SFRP4 secreted frizzled-related protein 4 precursor, SREBP Sterol regulatory element binding proteins, SMAD Sterile alpha motif domain-containing protein, SOD Superoxide dismutase, sTNFR Soluble TNF a receptor, TACE TNFα alpha cleavage protease, TFPI Tissue factor pathway inhibitor, TG Triglycerides, TGF β Transforming growth factor-β, TIMP Tissue inhibitor of metalloproteinases, TNF α Tumor necrosis factors-α, TNFR TNF α receptor, THP Tamm-Horsfall protein, TLR Toll-like receptors, TnI Troponin I, tPA Tissue plasminogen activator, TSP Thrombospondin, Uri Uristatin, uTi Urinary trypsin inhibitor, uPA Urokinase-type plasminogen activator, uPAR uPA receptor, VCAM Vascular cell adhesion molecule, VEGF Vascular endothelial growth factor, and YKL-40 Chitinase-3-like protein.

Secreted cell free target rare molecules of metabolic interest highly expressed by pancreas include but are not limited include insulin, gluogen, transcription factor NKX6-1, PNLIPRP1 pancreatic lipase-related protein 1SYCN syncollin, PRS protease, serine, 1 (trypsin 1) Intracellular, CTRB2 chymotrypsinogen B2 Intracellular, CELA2A chymotrypsin-like elastase family, member 2A, CTRB1 chymotrypsinogen B1 Intracellular, CELA3A chymotrypsin-like elastase family, member 3A Intracellular, CELA3B chymotrypsin-like elastase family, member 3B Intracellular, CTRC chymotrypsin C (caldecrin), CPA1 carboxypeptidase A1 (pancreatic) Intracellular, PNLIP pancreatic lipase, and CPB1 carboxypeptidase B1 (tissue), AMY2A amylase, alpha 2A (pancreatic), and CTFR cystic fibrosis transmembrane conductance regulator

Cell free target rare molecules of metabolic interest that are genes highly and specifically expressed by pancreas include but are not limited AMY2A Amylase, alpha 2A (pancreatic), AMY2B Amylase, alpha 2B (pancreatic), AQP12A Aquaporin 12A, AQP12B Aquaporin 12B Predicted membrane proteins Tissue enriched, CEL Carboxyl ester lipase, CELA2A Chymotrypsin-like elastase family, member 2A, CELA2B Chymotrypsin-like elastase family, member 2B, CELA3A Chymotrypsin-like elastase family, member 3A, CELA3B Chymotrypsin-like elastase family, member 3B, CLPS Colipase, pancreatic, CLPSL1 Colipase-like 1, CPA1 Carboxypeptidase A1 (pancreatic), CPA2 Carboxypeptidase A2 (pancreatic), CPB1 Carboxypeptidase B1 (tissue), CTRB1 Chymotrypsinogen B1, CTRB2 Chymotrypsinogen B2, CTRC Chymotrypsin C (caldecrin), CTRL Chymotrypsin-like, G6PC2 Glucose-6-phosphatase, catalytic, 2, GP2 Glycoprotein 2 (zymogen granule membrane), IAPP Islet amyloid polypeptide, INS Insulin, KIRREL2 Kin of IRRE like 2 (Drosophila), PDIA2 Protein disulfide isomerase family A, member 2, PLA2G1B Phospholipase A2, group B3 (pancreas), PM20D1 Peptidase M20 domain containing 1, PNLIP Pancreatic lipase, PNLIPRP1 Pancreatic lipase-related protein 1 Predicted secreted proteins PPY Pancreatic polypeptide, PRSS1 Protease, serine, 1 (trypsin 1), PRSS3 Protease, serine, 3, PRSS3P2 Protease, serine, 3 pseudogene 2, PTF1A Pancreas specific transcription factor, 1a, RBPJL Recombination signal binding protein for immunoglobulin kappa J region-like, SERPINI2 Serpin peptidase inhibitor, clade I (pancpin), SPINK1 Serine peptidase inhibitor, Kazal type, and SYCN Syncollin Predicted secreted proteins Tissue enriched

### Examples of Methods

In accordance with the invention, the methods are assays where the sample is filtered through a porous matrix such that cells or particles are trapped by size exclusion and used to generate analytical labels. In some methods, one or more of the populations of rare molecules measured are cell bound. In other methods, one or more of the populations of rare molecules measured are cell free molecules. In other methods, one or more of the populations of rare cells are measured.

In examples were a particle is used to capture the rare molecules or rare cells, the particle is retained by size exclusion on a porous matrix and separated from non-rare molecules and non-rare cells. The particle can capture the rare molecules or rare cells by use of affinity agents that facilitate the binding of rare molecules or rare cells to form particle-bound rare molecules or rare cell. In other examples, one or more cells are retained by size exclusion on a porous matrix and separated from non-rare molecules and non-rare cells.

In all methods, the concentration of one or more different populations of target rare molecules can be reacted further with an affinity agent to form a retained affinity agent sample on a porous matrix. The retained affinity agent that comprises a specific binding partner that is specific for and binds to a target rare molecule of one of the populations of the target rare molecules. The retained affinity agent comprises an analytical label precursor or facilitates the formation of an analytical label from an analytical label precursor. The retained affinity agent may be non-particulate or particulate and comprises an analytical label precursor that is also retained on the porous matrix after filtration, and which allows the formation of an analytical label. In some examples a liquid reagent is added to porous matrix to generate analytical labels.

In all examples, a porous matrix is used to capture the rare molecules or rare cells. The concentration of one or more different populations of target rare molecules is enhanced over that of the non-rare molecules to form a concentrated sample. In all examples, non-rare molecules and cells are filtered through the porous matrix and not retained by capture particles or by size exclusion and therefore not further reacted with affinity agents. In some examples, the sample is subjected to a filtration procedure using a hydrodynamic force applied to the sample on the porous matrix to facilitate passage of non-rare molecule, non-rare cells and other particles through the matrix. The level of vacuum applied is dependent on one or more of the nature and size of the different populations of rare cells, particles, reagents, the nature of the porous matrix, and the size of the pores of the porous matrix.

Affinity agents are binding partners that are specific for the non-cellular target rare molecule. The phrase “binding partner” refers to a molecule that is a member of a specific binding pair. A member of a specific binding pair is one of two different molecules having an area on the surface or in a cavity, which specifically binds to and is thereby defined as complementary with a particular spatial and polar organization of the other molecule. The members of the specific binding pair may be members of an immunological pair such as antigen-antibody or hapten-antibody, biotin-avidin, hormones-hormone receptors, enzyme-substrate, nucleic acid duplexes, IgG-protein A, and polynucleotide pairs such as DNA-DNA, DNA-RNA, oligo poly nucleotides like poly T or poly A for example. The binding partner may be bound, either covalently or non-covalently, to the particle of the particle reagent. “Non-covalently” means that the binding partner is bound to the particle as the result of one or more of hydrogen bonding, van der Waals forces, electrostatic forces, hydrophobic effects, physical entrapment in the particles, and charged interactions, for example. “Covalently” means that the binding partner is bound to the particle by a bond or a linking group, which may be aliphatic or aromatic and may comprise a chain of 2 to about 60 or more atoms that include carbon, oxygen, sulfur, nitrogen and phosphorus.

The composition of the capture particle entity may be organic or inorganic, magnetic or non-magnetic. Organic polymers include, by way of illustration and not limitation, nitrocellulose, cellulose acetate, poly(vinyl chloride), polyacrylamide, polyacrylate, polyethylene, polypropylene, poly(4-methylbutene), polystyrene, poly(methyl methacrylate), poly-(hydroxyethyl methacrylate), poly(styrene/divinylbenzene), poly(styrene/acrylate), poly(ethylene terephthalate), melamine resin, nylon, poly(vinyl butyrate), for example, either used by themselves or in conjunction with other materials and including latex, microparticle and nanoparticle forms thereof. The particles may also comprise carbon (e.g., carbon nanotubes), metal (e.g., gold, silver, and iron, including metal oxides thereof), colloids, dendrimers, dendrons, nucleic acids, Branch chain-DNA, and liposomes.

The diameter of the particle entity is dependent on one or more of the nature of the target rare molecule, the nature of the sample, the nature and the pore size of a filtration matrix, the adhesion of the particle to matrix, the size of cell to be captured at the surface of the particle, the surface of the matrix, the liquid ionic strength, liquid surface tension and components in the liquid, and the number, size, shape and molecular structure of attached affinity agent and analytical label precursors. When a porous matrix is employed in a filtration separation step, the diameter of the particles must be large enough to reduce background contribution to an acceptable level but not so large as to achieve inefficient separation of the particles from non-rare molecules. In some examples, the average diameter of the particles should be at least about 0.02 microns (20 nm) and not more than about 200 microns, or not more than about 120 microns. In some examples, the particles have an average diameter from about 0.1 microns to about 20 microns, or about 0.1 microns to about 15 microns, or about 0.1 microns to about 10 microns, or about 0.02 microns to about 0.2 microns, or about 0.2 microns to about 1 micron, or about 1 micron to about 5 microns, or about 1 micron to about 20 microns, or about 1 micron to about 15 microns, or about 1 micron to about 10 microns, or about 5 microns to about 20 microns, or about 5 to about 15 microns, or about 5 to about 10 microns, or about 6 to about 15 microns, or about 6 to about 10 microns. In some examples, the adhesion of the particles to the surface is so strong that the particle diameter can be smaller than the pore size of the matrix. In other examples, the particles are sufficiently larger than the pore size of the matrix such that physically the particles cannot fall through the pores.

The combination of the sample and the capture particle entities can be held for incubation period and temperature to permit the binding of target rare molecules or cells with corresponding binding partners of the capture particle entities. Incubation temperatures normally employed, may range from about 5° C. to about 95° C. or from about 25° C. to about 37. ° C. or from about 20° C. to about 45° C., for example. The time period for an incubation period is about 0.2 seconds to about 6 hours, or about 2 seconds to about 1 hour, or about 1 to about 5 minutes.

Contact of the sample with the porous matrix is continued for a period-of-time sufficient to achieve retention of cellular target rare molecules and/or particle-bound non-cellular target rare molecules on a surface of the porous matrix to obtain a surface of the porous matrix having different populations of target rare cells and/or particle-bound target rare molecules as discussed above. The period-of-time is dependent on one or more of the nature and size of the different populations of target rare cells and/or particle-bound target rare molecules, the nature of the porous matrix, the size of the pores of the porous matrix, the level of vacuum applied to the blood sample on the porous matrix, the volume to be filtered, and the surface area of the porous matrix. In some examples, the period-of-time is about 1 minute to about 1 hour, about 5 minutes to about 1 hour, or about 5 minutes to about 45 minutes, or about 5 minutes to about 30 minutes, or about 5 minutes to about 20 minutes, or about 5 minutes to about 10 minutes, or about 10 minutes to about 1 hour, or about 10 minutes to about 45 minutes, or about 10 minutes to about 30 minutes, or about 10 minutes to about 20 minutes.

In methods in accordance with the principles described herein, the concentrated sample is incubated with, for each different population of target rare molecules or rare cells, an affinity agent that comprises a specific binding partner that is specific for and binds to a target rare molecule of one of the populations of the target rare molecule.

Specific binding involves the specific recognition of one of two different molecules for the other compared to substantially less recognition of other molecules. On the other hand, non-specific binding involves non-covalent binding between molecules that is relatively independent of specific surface structures. Non-specific binding may result from several factors including hydrophobic interactions between molecules.

Antibodies specific for a target molecule for use in immunoassays to identify cells can be monoclonal or polyclonal. Such antibodies can be prepared by techniques that are well known in the art such as immunization of a host and collection of sera (polyclonal) or by preparing continuous hybrid cell lines and collecting the secreted protein (monoclonal) or by cloning and expressing nucleotide sequences or mutagenized versions thereof coding at least for the amino acid sequences required for specific binding of natural antibodies.

Antibodies may include a complete immunoglobulin or fragment thereof, which immunoglobulins include the various classes and isotypes, such as IgA, IgD, IgE, IgG1, IgG2a, IgG2b and IgG3, IgM, etc. Fragments thereof may include Fab, Fv and F(ab′)₂, and Fab′, for example. In addition, aggregates, polymers, and conjugates of immunoglobulins or their fragments can be used where appropriate so long as binding affinity for a particular molecule is maintained.

Polyclonal antibodies and monoclonal antibodies may be prepared by techniques that are well known in the art. For example, in one approach monoclonal antibodies are obtained by somatic cell hybridization techniques. Monoclonal antibodies may be produced according to the standard techniques of Köhler and Milstein, Nature 265:495-497, 1975. Reviews of monoclonal antibody techniques are found in Lymphocyte Hybridomas, ed. Melchers, et al. Springer-Verlag (New York 1978), Nature 266: 495 (1977), Science 208: 692 (1980), and Methods of Enzymology 73 (Part B): 3-46 (1981). In general, monoclonal antibodies can be purified by known techniques such as, but not limited to, chromatography, e.g., DEAE chromatography, ABx chromatography, and HPLC chromatography; and filtration, for example.

The affinity agent may be a nucleic acid (e.g., polynucleotide) that is complementary to a target nucleic acid. Polynucleotides refer to a polymeric form of nucleotides of any length, either deoxyribonucleotides or ribonucleotides, or analogs thereof. The following are non-limiting examples of polynucleotides: coding or non-coding regions of a gene or gene fragment, loci (locus) defined from linkage analysis, exons, introns, messenger RNA (mRNA), transfer RNA, ribosomal RNA, xenonucleic acids, ribozymes, cDNA, recombinant polynucleotides, branched polynucleotides, plasmids, vectors, isolated DNA of any sequence, isolated RNA of any sequence, nucleic acid probes, and primers. A polynucleotide may comprise modified nucleotides such as, for example, methylated nucleotides and nucleotide analogs. If present, modifications to the nucleotide structure may be imparted before or after assembly of the polymer. The sequence of nucleotides may be interrupted by non-nucleotide components. A polynucleotide may be further modified, such as by conjugation with a labeling component.

The affinity agent comprises one or more analytical label precursor that can generate one or more than one analytical label. Each analytical label can correspond to a specific target rare molecule or to a populations of target rare molecules or to a group of target rare molecules. The analytical label can differentiate one of the populations of target rare molecules from other populations of molecules whether rare or not. The retained analytical labels on the porous matrix are subjected to analysis to determine the presence and/or amount of each different analytical labels. The presence and/or amount of each different analytical labels are related to the present and/or amount of each different population of target rare cells and/or particle-bound target rare molecules.

An analytical label precursor may be attached to an affinity agent (to yield a modified affinity agent) covalently bound either directly by a bond or through the intermediacy of a linking group. In some embodiments the preparation of a modified affinity agent may be carried out by employing functional groups suitable for attaching the analytical label precursor or the alteration agent, to the affinity agent by a direct bond. The nature of the functional groups employed is dependent, for example, on one or more of the nature of the analytical label precursor, and the nature of the affinity agent including the nature of one or more different particles such as, e.g., capture particles and label particles that may be part of the affinity agent. A large number of suitable functional groups are available for attaching to amino groups and alcohols; such functional groups include, for example, activated esters including, e.g., carboxylic esters, imidic esters, sulfonic esters and phosphate esters; activated nitrites; aldehydes; ketones; and alkylating agents.

The linking group may be a chain of from 1 to about 60 or more atoms, or from 1 to about 50 atoms, or from 1 to about 40 atoms, or from 1 to 30 atoms, or from about 1 to about 20 atoms, or from about 1 to about 10 atoms, each independently selected from the group normally consisting of carbon, oxygen, sulfur, nitrogen, and phosphorous, usually carbon and oxygen. The number of heteroatoms in the linking group may range from about 0 to about 8, from about 1 to about 6, or about 2 to about 4. The atoms of the linking group may be substituted with atoms other than hydrogen such as, for example, one or more of carbon, oxygen and nitrogen in the form of, e.g., alkyl, aryl, aralkyl, hydroxyl, alkoxy, aryloxy, or aralkoxy groups. As a general rule, the length of a particular linking group can be selected arbitrarily to provide for convenience of synthesis with the proviso that there is minimal interference caused by the linking group with the ability of the linked molecules to perform their function related to the methods disclosed herein.

The linking group may be aliphatic or aromatic. When heteroatoms are present, oxygen will normally be present as oxy or oxo, bonded to carbon, sulfur, nitrogen or phosphorous; sulfur will be present as thioether or thiono; nitrogen will normally be present as nitro, nitroso or amino, normally bonded to carbon, oxygen, sulfur or phosphorous; phosphorous will be bonded to carbon, sulfur, oxygen or nitrogen, usually as phosphonate and phosphate mono- or diester. Functionalities present in the linking group may include esters, thioesters, amides, thioamides, ethers, ureas, thioureas, guanidines, azo groups, thioethers, carboxylate and so forth. The linking group may also be a macro-molecule such as polysaccharides, peptides, proteins, nucleotides, and dendrimers.

The modified affinity agents can be prepared by linking each different affinity agent in separate, individual reactions to the analytical label precursor and then combining the modified affinity agents to form a mixture comprising the modified affinity agents. Alternatively, the different affinity agents can be combined and the reaction to link the affinity agents to the analytical labels precursor can be carried out on the combination. This allows the method to be multiplexed for more than one result at a time.

An amount of each different modified affinity agent that is employed in the methods in accordance with the principles described herein is dependent on one or more of the nature and potential amount of each different population of target rare molecules, the nature of the analytical labels, the nature of the affinity agent, the nature of a cell if present, the nature of a particle if employed, and the amount and nature of a blocking agent if employed, for example. In some examples, the amount of each different modified affinity agent employed is about 0.001 μg/μL to about 100 μg/μL, or about 0.001 μg/μL to about 80 μg/μL, or about 0.001 μg/μL to about 60 μg/μL, or about 0.001 μg/μL to about 40 μg/μL, or about 0.001 μg/μL to about 20 μg/μL, or about 0.001 μg/μL to about 10 μg/μL, or about 0.5 μg/μL to about 100 μg/μL, or about 0.5 μg/μL to about 80 μg/μL, or about 0.5 μg/μL to about 60 μg/μL, or about 0.5 μg/μL to about 40 μg/μL, or about 0.5 μg/μL to about 20 μg/μL, or about 0.5 μg/μL to about 10 μg/μL, for example.

In one example, sample is collected into a container with a suitable buffer. The collected sample is subjected to filtration to concentrate the number of cell-bound target rare molecules over that of other molecules in the sample such as, for example, non-rare cells. An affinity agent that comprises an analytical labels precursor linked to an antibody that is specific for the cell-bound target rare molecule is combined with the concentrated sample retained on a matrix of a filtration device. After a suitable incubation period, the matrix is washed with a buffer. An alteration agent is added to the sample on the matrix. The analytical labels precursor of the affinity agent is part of an immune complex comprising the affinity agent and the cell-bound target molecule. The matrix of the filtration device is subjected to analysis. If the target rare molecule is present in the sample, the produced analytical labels corresponds to the target rare molecule. If the target rare molecule is present in the sample, the analytical labels will give a distinctive spectrum that corresponds to the target rare molecule. In the above example, detection of only one target rare molecule is depicted; however, it is to be appreciated that any number of target rare molecules may be determined in a single method on a single sample using various analytical labels precursors as discussed above as discussed above.

In another example, sample is collected into a container with a suitable cell buffer. In this example, the target rare molecule is non-particulate, i.e., the target rare molecule is not bound to a cell or other particle. The collected sample is combined with a particle reagent that comprises a particle to which is attached an antibody for the target rare molecule. After an incubation period to permit binding of the non-cell-bound target rare molecule to the antibody on the particle to give particle-bound non-cell-bound target rare molecule, the sample is subjected to filtration to concentrate the number of particle-bound non-cell-bound target rare molecules over that of other molecules in the sample such as, for example, non-rare cells. Sample retained on the surface of the filtration device is washed with a suitable buffer. An affinity agent that comprises an analytical label precursor linked to an antibody that is specific for the particle-bound non-cell-bound target rare molecule is combined with the concentrated sample retained on a matrix of a filtration device. After a suitable incubation period, the matrix is washed with a buffer. An alteration agent is added to the sample on the matrix. The analytical labels precursor of the affinity agent is part of an immune complex comprising the affinity agent and the particle-bound non-cell-bound target molecule. The matrix of the filtration device is subjected to analysis. If the target rare molecule is present in the sample, the produced analytical labels corresponds to the target rare molecule. If the target rare molecule is present in the sample, the analytical labels will give a distinctive spectrum that corresponds to the target rare molecule. In the example above, detection of only one non-cell-bound target rare molecule is depicted; however, it is to be appreciated that any number of target rare molecules (both cell-bound and non-cell bound) may be determined in a single method on a single sample using various analytical labels precursors as discussed above.

### Examples of Methods Employing Particle Amplification

In one approach, particle amplification is utilized and provides for attaching a larger number of analytical labels to affinity labels. In one example, a particle can be coated with many smaller analytical label precursors along with one or more affinity agent as a “label particle”. The label particle can contain the analytical label on the surface or inside particles, and contain multiples labels per label particle since the size of label is smaller than the label particle. In this approach, very low background levels are realized. The analytical label precursor may be attached to “label particle” and affinity agent using methods described above for attachment of affinity agent to analytical label precursor.

The phrase “particle amplification” refers to the formation of enhanced number of analytical label indicative of a single label particle binding a single target rare molecule. In some examples, the number of label molecules on particle that is indicative of a target rare molecule is 10¹⁰ to 1, or 10⁹ to 1, or 10⁸ to 1, or 10⁷ to 1, or 10⁶ to 1, or 10⁵ to 1, or 10⁴ to 1, or 10³ to 1, or 10² to 1, or 10 to 1, or 10¹⁰ to 10², or 10¹⁰ to 10³, or 10¹⁰ to 10⁴, or 10¹⁰ to 10⁵, for example. The composition of the label particle may be, for example, as described above for capture particles.

In some examples, particle amplification is employed with a larger capture particle associated with a second affinity agent, such that a sandwich assay can be made with both the capture particle and the label particle bind to a rare molecule or rare cells. The size of the capture particle is large enough to accommodate one or more label particles. The ratio of label particles to a single capture particle may be 10⁶ to 1, or 10⁵ to 1, or 10⁴ to 1, or 10³ to 1, or 10² to 1, or 10 to 1, for example. The diameter of the capture particle is also dependent on one or more of the nature of the target rare molecule, the nature of the sample, the nature and the pore size of a filtration matrix, the adhesion of the particle to matrix, the surface of the particle, the surface of the matrix, the liquid ionic strength, liquid surface tension and components in the liquid, and the number, size, shape and molecular structure of associated label particles, for example. When a porous matrix is employed in a filtration separation step, the diameter of the label particles must be large enough to hold a number of analytical label to achieve the benefits of particle amplification in accordance with the principles described herein but small enough to be pass through the pores of a porous matrix whereas the capture particle should be large enough not pass through the pores of a porous matrix. In some examples in accordance with the principles described herein, the average diameter of the capture particles should be at least about 0.1 microns and not more than about 1 micron, or not more than about 5 microns. In some examples, the capture particles have an average diameter from about 0.1 microns to about 5 microns, or about 1 micron to about 3 microns, or about 4 microns to about 5 microns, about 0.2 microns to about 0.5 microns, or about 1 micron to about 3 microns, or about 4 microns to about 5 microns.

The composition of the label particle may be, for example, as described above for capture particle entities. The size of the label particles is dependent on one or more of the nature and size of the capture particle, the nature and size of the analytical label, or the analytical label precursor, the nature of the target rare molecule, the nature of the sample, the nature and the pore size of a filtration matrix, the surface of the particle, the surface of the matrix, the liquid ionic strength and, liquid surface tension and components in the liquid. In some examples in accordance with the principles described herein, the average diameter of the label particles should be at least about 0.01 microns and not more than about 0.1 microns, or not more than about 1 micron. In some examples, the label particles have an average diameter from about 0.01 microns to about 1 micron, or about 0.01 microns to about 0.5 microns, or about 0.01 microns to about 0.4 microns, or about 0.01 microns to about 0.3 microns, or about 0.01 microns to about 0.2 microns, or about 0.01 microns to about 0.1 microns, or about 0.01 microns to about 0.05 microns, or about 0.1 microns to about 0.5 microns, or about 0.05 microns to about 0.1 microns. In other examples, the label particle may be a silica nanoparticle, which can be linked to magnetic capture particles that have free carboxylic acid groups by ionic association.

The number of analytical labels or analytical label precursors associated with the label particle is dependent on one or more of the nature and size of the analytical labels or analytical labels precursor, the nature and size of the label particle, the nature of the linker arm, the number and type of functional groups on the label particle, and the number and type of functional groups on the analytical label precursor, for example. In some examples, the number of analytical labels or analytical label precursors associated with a single label particle is about 10⁷ to 1, or about 10⁶ to 1, or about 10⁵ to 1, or about 10⁴ to 1, or about 10³ to 1, or about 10² to 1, or about 10 to 1.

The size of the particle aggregates is dependent on one or more of the nature and size of the capture particle, the nature and size of the label particle, the nature and size of the linking groups, the nature and size of the analytical label or the analytical labels precursor, the nature of the alteration agent, the nature of the target rare molecule, the nature of the sample, the nature and the pore size of a filtration matrix, the surface of the particle, the surface of the matrix, the liquid ionic strength and, liquid surface tension and components in the liquid. In some examples in accordance with the principles described herein, the average diameter of the particle aggregates is at least about 0.1 microns and not more than about 500 microns, or not more than about 1,000 microns. In some examples, the particle aggregates have an average diameter from about 0.1 microns to about 1,000 microns, or about 0.1 microns to about 500 microns, or about 0.1 microns to about 100 microns, or about 0.1 microns to about 10 microns, or about 0.1 microns to about 5 microns, or about 0.1 microns to about 1 micron, or about 1 micron to about 10 microns, or about 10 microns to about 500 microns, or about 10 microns to about 100 microns.

The methods described herein involve trace analysis, i.e., minute amounts of material on the order of 1 to about 100,000 copies of rare cells or target rare molecules. Since this process involves trace analysis at the detection limits of the mass spectrometers, these minute amounts of material can only be detected when detection volumes are extremely low, for example, 10⁻¹⁵ liter, so that the concentrations are within the detection. Given evaporation is likely and that “all” of the mass label must be removed must be removed for detection of 1 cell, unamplified methods are unlikely. “All” means that 100% of the analytical labels precursor capture particles would be needed to detect one rare cell or target rare molecule. The methods described herein involve trace analysis by amplification, i.e., converting the minute amounts of material to the order of about 10⁷ to about 10¹⁰ copies of every rare cell or target rare molecule. In this case only substantially all of the capture particles for each cell or capture particle should be recovered to allow concentrations within the detection limits at reasonable detection volumes of, e. g., about 10⁻⁶ liter. The phrase “substantially all” means that at least about 70 to about 99% measured by the reproducibility in amounts of analytical labels released for a rare cell or a target rare molecule. Reproducible release is directly related to the formation and complete recovery of the capture and label particles with a low variance of about 1 to about 30%.

Obtaining reproducibility in amounts of analytical labels released for a rare cell or a target rare molecule requires measuring the binding of affinity reaction to analyte and complete washing of unbound the capture and label particles. Therefore, in one approach the capture particles, label particles, linking group, analytical labels and/or analytical label precursor may be made fluorescent by virtue of the presence of a fluorescent molecule in addition to being an optical, electrochemical or MS labels. The fluorescent molecule can then be measured by microscopic analysis and compared to expected results for sample containing and lacking analyte. Fluorescent molecule include but not limited to, FITC, rhodamine compounds, phycoerythrin, phycocyanin, allophycocyanin, o-phthaldehyde, fluorescent rare earth chelates, amino-coumarins, umbelliferones, oxazines, Texas red, acridones, perylenes, indacines such as, e.g., 4,4-difluoro-4-bora-3a,4a-diaza-s-indacene and variants thereof, 9,10-bis-phenylethynyl-anthracene, squaraine dyes and fluorescamine, for example. A fluorescent microscope may then be used to determine the location of the capture particles, label particles, linking group, analytical labels and/or analytical label precursors before and after treatment. This serves as a confirmative measure of the system function and is valued for additional information on the location of the rare cell or target rare molecule on the cellular structure or a capture particle.

### Kit for Conducting Methods

The apparatus and reagents for conducting the method in accordance with the invention may be present in a kit useful for conveniently performing the method. In one embodiment a kit comprises in packaged combination modified affinity agents, one for each different target rare molecule. The kit may also comprise one or more unlabeled antibodies or nucleic acid probes directed at non-rare cells so that they can be eliminated from analysis. Depending on whether the modified affinity agent comprises an analytical label precursor or an alteration agent, the kit may also comprise the other of the analytical label precursor or the alteration agent that is not part of the modified affinity agent. The kit may also include a substrate for a moiety that reacts with an analytical label precursor to generate an analytical label.

In addition, the kit may also include one or more of a fixation agent, a permeabilization agent, and a blocking agent to prevent non-specific binding to the cells. Other reagents for performing the method may also be included in the kit, the nature of such reagents depending upon the particular format to be employed. The reagents may each be in separate containers or various reagents can be combined in one or more containers depending on the cross-reactivity and stability of the reagents. The kit can further include other separately packaged reagents for conducting the method such as ancillary reagents, binders, containers for collection of samples, and supports for cells such as, for example, microscope slides, for conducting an analysis, for example.

The relative amounts of the various reagents in the kits can be varied widely to provide for concentrations of the reagents that substantially optimize the reactions that need to occur during the present methods and further to optimize substantially the sensitivity of the methods. Under appropriate circumstances one or more of the reagents in the kit can be provided as a dry powder, usually lyophilized, including excipients, which on dissolution will provide for a reagent solution having the appropriate concentrations for performing a method in accordance with the principles described herein. The kit can further include a written description/instructions of a method utilizing reagents in accordance with the principles described herein.

The phrase “at least” as used herein means that the number of specified items may be equal to or greater than the number recited. The phrase “about” as used herein means that the number recited may differ by plus or minus 10%; for example, “about 5” means a range of 4.5 to 5.5.

In some examples, samples are collected from the body of a subject into a suitable container such as, but not limited to, a cup, a bag, a bottle, capillary, or a needle, for example. Blood samples may be collected into VACUTAINER® containers. The container may contain a collection medium into which the sample is delivered. The collection medium is usually a dry medium and may comprise an amount of platelet deactivation agent effective to achieve deactivation of platelets in the blood sample when mixed with the blood sample. Platelet deactivation agents include, but are not limited to, chelating agents such as, for example, chelating agents that comprise a triacetic acid moiety or a salt thereof, a tetraacetic acid moiety or a salt thereof, a pentaacetic acid moiety or a salt thereof, or a hexaacetic acid moiety or a salt thereof. In some examples, the chelating agent is ethylene diamine tetraacetic acid (EDTA) and its salts or ethylene glycol tetraacetate (EGTA) and its salts. The effective amount of platelet deactivation agent is dependent on one or more of the nature of the platelet deactivation agent, the nature of the blood sample, level of platelet activation and ionic strength. In some examples, for EDTA as the anti-platelet agent, the amount of dry EDTA in the container is that which will produce a concentration of about 1.0 to about 2.0 mg/mL of blood, or about 1.5 mg/mL of the blood. The amount of the platelet deactivation agent is that which is sufficient to achieve at least about 90%, or at least about 95%, or at least about 99% of platelet deactivation.

In some examples, where one or more of the target rare molecules are part of a cell, it may be desirable to fix the cells of the sample. Fixation of the cells immobilizes the cells and preserves cell structure and maintains the cells in a condition that closely resembles the cells in an in vivo-like condition and one in which the antigens of interest are able to be recognized by a specific affinity agent. The amount of fixative employed is that which preserves the cells but does not lead to erroneous results in a subsequent assay. The amount of fixative depends on one or more of the nature of the fixative and the nature of the cells. In some examples, the amount of fixative is about 0.05% to about 0.15% or about 0.05% to about 0.10%, or about 0.10% to about 0.15%, for example, by weight. Agents for carrying out fixation of the cells include, but are not limited to, cross-linking agents such as, for example, an aldehyde reagent (such as, e.g., formaldehyde, glutaraldehyde, and paraformaldehyde,); an alcohol (such as, e.g., C₁-C₅ alcohols such as methanol, ethanol and isopropanol); a ketone (such as a C₃-C₅ ketone such as acetone); for example. The designations C₁-C₅ or C₃-C₅ refer to the number of carbon atoms in the alcohol or ketone. One or more washing steps may be carried out on the fixed cells using a buffered aqueous medium.

If necessary after fixation, the cell preparation is also subjected to permeabilization. In some instances, a fixation agent such as, for example, an alcohol (e.g., methanol or ethanol) or a ketone (e.g., acetone) also results in permeabilization and no additional permeabilization step is necessary. Permeabilization provides access through the cell matrix to target molecules of interest. The amount of permeabilization agent employed is that which disrupts the cell matrix and permits access to the target molecules. The amount of permeabilization agent depends on one or more of the nature of the permeabilization agent and the nature and amount of the cells, for example. In some examples, the amount of permeabilization agent is about 0.01% to about 10%, or about 0.1% to about 10%, for example. Agents for carrying out permeabilization of the cells include, but are not limited to, an alcohol (such as, e.g., C₁-C₅ alcohols such as methanol and ethanol); a ketone (such as a C₃-C₅ ketone such as acetone); a detergent (such as, e.g., saponin, TRITON® X-100, and TWEEN®-20); for example. One or more washing steps may be carried out on the permeabilized cells using a buffered aqueous medium.

Where one or more of the target rare molecules are part of a cell, the aqueous medium may also comprise a lysing agent for lysing of cells. A lysing agent is a compound or mixture of compounds that disrupt the integrity of the cells thereby releasing intracellular contents of the cells. Examples of lysing agents include, but are not limited to, non-ionic detergents, anionic detergents, amphoteric detergents, low ionic strength aqueous solutions (hypotonic solutions), bacterial agents, aliphatic aldehydes, and antibodies that cause complement dependent lysis, for example. Various ancillary materials may be present in the dilution medium. All of the materials in the aqueous medium are present in a concentration or amount sufficient to achieve the desired effect or function.

The following examples further describe the specific embodiments of the invention by way of illustration and not limitation and are intended to describe and not to limit the scope of the invention. Parts and percentages disclosed herein are by volume unless otherwise indicated.

### EXAMPLES

All chemicals may be purchased from the Sigma-Aldrich Company (St. Louis Mo.) unless otherwise noted.

### ABBREVIATIONS

K₃EDTA=potassium salt of ethylenediaminetetraacetate
WBC=white blood cells
DAPI=4′,6-diamidino-2-phenylindole
DMSO=dimethylsulfoxide (ThermoFisher Scientific)
min=minute(s)
μm=micron(s)
mL=milliliter(s)
mg=milligrams(s)
μg=microgram(s)
PBS=phosphate buffered saline (3.2 mM Na₂HPO₄, 0.5 mM KH₂PO₄, 1.3 mM

### KCl, 135 mM NaCl, pH 7.4)

mBar=millibar
w/w=weight to weight
RT=room temperature
hr=hour(s)
QS=quantity sufficient
ACN=acrylonitrile
TFA=trifluoroacetic acid
TCEP=tris(2-carboxyethyl)phosphine hydrochloride (Sigma-Aldrich)
SPDP=N-Succinimidyl 3-(2-pyridyldithio)propionate)
Ab=antibody
mAb=monoclonal antibody
vol=volume
MW=molecular weight
wt.=weight
Rare Cells=SKBR3 human breast cancer cells (ATCC)

### CK=Cytokeratin

Her2nue=Human epidermal growth factor receptor 2
Rare Molecule=either Her2nue or CK proteins and mRNA obtained from lyzed SKBR3 human breast cancer cells (ATCC)
Label particle=Propylamine-functionalized silica nano-particles 200 μm, mesoporous pore sized 4 nm
Glass slide=FISHERBRAND™ SUPERFROST™ Plus Microscope Slides (ThermoFisher Scientific Inc.)
Blocking agent=Casien, the blocking solution (Candor Biosience GmbH, Allgau Germany)
Porous Matrix=WHATMAN® NUCLEOPORE™ Track Etch matrix, 25 mm diameter and 8.0 and 1.0 μM pore sizes
ESI=electrospray MS analysis on a LTQ Thermo Fisher Mass Spectrometer

### Example 1

### Release of Liquid Droplets from Porous Matrix and Microfluidic Surface

Five key designs were employed for testing as shown in Table 1 by the making of the components and using the apparatus, kit or method. The first component used is the porous matrix (as listed above) bonded with thermal adhesive to either a liquid holding well or holder made of polystyrene or 3D printed plastics. The bond was an air tight seal. The porous matrix was a polycarbonate membrane of 6 mm diameter circle that was flexible and had about 100,000 pores of 8 μm diameter. The angle formed at the intersection of a surface of the porous matrix and the hole of the pore varied from 30 to 150° between individual pores. The second component used was a microfluidic surface with liquid volume area and least one exit hole that was made of metal by micro-milling or by 3D printed plastics. The exit hole diameter varied from 50 to 1000 μm diameter and the liquid volume varied from 10 nL to 30 μL. The third component used was a liquid receiving well such a PCR vial or a PCR plate. The three components were fabricated in single well and 96-well array formats. In some cases, gaskets were fabricated for sealing between components and in other cases the outer and inner dimension of the components were adjusted by fit and form to make an air tight seal between components. Liquid droplets were collected and compared against expected value in over 6 attempts (see Table 1)

TABLE 1
Comparison of design for removal of small volumes from a device

| | | | | Average amounts of |
|---|---|---|---|---|
| | | | | liquid droplets |
| | | | | recovered and |
| | | | | coefficient of |
| | | | | variation of amount |
| Design | Component 1 | Component 2 | Component 3 | recovered |
| 1 | Porous matrix attached to | None | None | Low recovery of 10 |
| | liquid holding well | | | to 30% and high |
| | | | | variation of >100% |
| 2 | Porous matrix attached to | Microfluidic | None | High recovery of |
| | liquid holding well | surface with liquid | | >90% and high |
| | | volume area and | | variation of <10% |
| | | least one exit hole | | |
| 3 | None | Microfluidic | None | Medium recovery of |
| | | surface with liquid | | >60% and medium |
| | | volume area and | | variation of 30 to |
| | | least one exit hole | | 60% |
| 4 | Porous matrix attached to | Microfluidic | Liquid receiving | High recovery of |
| | liquid holding well | surface with liquid | area | >90% and high |
| | | volume area and | | variation of <10% |
| | | least one exit hole | | |
| 5 | Porous matrix in holder | Microfluidic | Liquid receiving | High recovery of |
| | associated to liquid holding | surface with liquid | area | >90% and high |
| | well | volume area and | | variation of <10% |
| | | least one exit hole | | |

Design 1 lacked all the essential elements of the principles discloses in the invention. The average amounts of liquid droplets recovered were very low and coefficient of variation of amount recovered was very high making it essential impractical for analytical analysis. The design was prone to liquid evaporation and additionally impractical for analytical analysis as unable to holding liquid on the porous matrix without a hydrodynamic force applied to force liquid up from the bottom of the porous matrix, opposite to the direction needed to remove liquid.

Design 2 contained all the essential elements of the principles discloses in the invention. The average amounts of liquid droplets recovered were high and coefficient of variation of amount recovered was very low making it practical for analytical analysis. The design was not prone to liquid evaporation and allowed analytical analysis by being able to hold liquid on top of the porous matrix, when a hydrodynamic force was not applied or applied with enough force to move liquid down to the liquid volume area but not to pass to the microfluidic surface exit. In this case, microfluidic surface exit was a restrictive structure acting as a stop function but allowed greater hydrodynamic force to move liquid completely out the exit hole.

Design 3 lacked all the essential elements of the principles discloses in the invention. The average amounts of liquid droplets recovered were very low and coefficient of variation of amount recovered was very high making it essentially impractical for analytical analysis. The design was prone to liquid evaporation and additionally impractical for analytical analysis and was unable to conduct size exclusion filtration without many exit holes spread across the surface in which case it acted as Design 1 and was unable to gather a liquid droplet for the same reasons that Design 1 failed.

It was also found that if the microfluidic surface had structures that retained liquids inside the liquid volume area, it was ineffective at complete sample removal. Microfluidic surfaces that gather and completely move a liquid droplet through the exit are in accordance with principles described. Structures and features on microfluidic surfaces that failed to gather and complete move a liquid droplet with structures were found to be post or ridges, grooves, or bumps parallel to flow of liquid, that trapped liquids. Multiple exit holes widely distributed and not centrally located failed to gather and completely move a liquid droplet. Structures and features on microfluidic surfaces that did gather and complete move a liquid droplet with structures were found to be planes, cones, ridges, grooves, or bumps aligned with the flow of liquid. Multiple exit holes closely distributed and centrally located did gather and completely moved a liquid droplet. Additional, structures and features on microfluidic surfaces with droplet-inducing features on the outside of microfluidic surface to prevented liquids from spreading on outer surfaces and did not gather and completely remove liquids from the exit hole.

Design 4 and 5 contained all the essential elements of the principles discloses in the invention. In these cases, the use of the holder or the addition of a liquid receiving area well without losing the advantages of Design 2. The average amounts of liquid droplets recovered were high and coefficient of variation of amount recovered was very low making it practical for analytical analysis. Additionally, it was found that Components 1, 2 and 3 can be associated with and without a gasket or with and without a holder without losing the advantages of Design 3 as long as the components were associated by an air tight fit using force or shape.

Design 2, 4 and 5 contained all the essential elements of the principles of the invention when tested under a variety of hydrodynamic forces and allowing the liquid to move from one liquid area to another liquid area. The hydrodynamic forces include gravity, vacuum, centrifugal force, air pressure, piezo electric, electrical field or capillary force. The equivalent forces were generated in the range of 1 to 200 millibar for all methods and all allowed the liquid to move from the one liquid area to another liquid area through components 1, 2 and 3 associated by direct contact. Generally, greater hydrodynamic forces are needed to move liquids through more restrictive microfluidic surfaces than the porous matrix. The liquid droplets could be stopped and held in the porous matrix or microfluidic surface when the surfaces, pores, exit holes, geometries, or shapes become restrictive enough to exceed the hydrodynamic force applied. A discrete liquid volume could be ejected from the liquid volume area by applying high hydrodynamic forces.

### Example 2

### Collection and Removal of Analytical Labels on Porous Matrix

Additional experiments were performed to determine the amount of analytical labels collected on a porous matrix and removed from the porous matrix using Designs 2 and 4. For Design 2 the analysis liquid was collected into capillary having atmospheric pressure inlet (API) of a THERMO LTQ (linear ion trap) mass 5 spectrometer (from Thermo Electron North America LLC) which was extended and bent at a 90° angle, such that the opening was pointing up. In all experiments, the exit of the microfluidic surface was positioned with the bottom side parallel to the ground approximately 1 mm distant from the bent capillary inlet. A potential was applied to Device 2 to generate a hydrodynamic force to move the analysis liquid from the microfluidic surface exit into the API. For Design 4 the analysis liquid was collected into a PCR tube associated with to the bottom of the microfluidic surfaces after the application of centrifugal force. The analysis liquid was collected into the nanospray capillary for nanoESI into the API of the THERMO LTQ. Acetonitrile and methanol were selected as the spray liquids removal of analysis liquid for both devices after test showed all solvent were removed. Equivalent hydrodynamic forces generated were in the range of 1 to 200 millibar.

A polypeptide analytical label comprised of 3-9 amino acids detectable as a mass label in accordance to the principles described and additionally conjugated to fluorescein were used as optical label and cysteine with a thiol as an electrochemical label. The polypeptide analytical label served as an optical, electrochemical or mass spectrometry analytical label. The polypeptide analytical label was detected as a mass label by THERMO LTQ. The mass spectra that were recorded showed peaks typical of spraying from the membrane in Device 2 or from the PCR vial via nanoESI in Device 4. The recovery of label was high >90% consistently reproduced at <3% variation from Device 2 and 4 but not Devices 1 and 3.

The polypeptide analytical label was detected as an optical label by fluorescent microscopy on the Leica DM5000 (Leica Microsystems GmbH, Wetzlar, Germany) fitted with a DFC365 FX black/white camera with NIR mode. A Lumen 200 fluorescent illumination system (Prior Scientific Inc., Rockland, Mass.) was used with the A4, L5, N3, and Y5 filter sets for 4′,6-diamidino-2-phenylindole (DAPI), fluorescein, Dylight 550 (Dy1550), and Dylight 650 (Dy1650) fluorophores, respectively. The fluorescent signal were recorded from the membrane in Device 2 or from the PCR vial in Device 4 demonstrating the measurement of analytical label on porous matrix or liquid sample

The thiol in the polypeptide analytical label was detected as an electrochemical label by high impedance/low current measurements using a Zennium X electrochemical workstation a as potentiostat and galvanostat (Zahner elektrick GmbH, Kronach, Germany). Detection of oxidation-reduction potential of thiol-disulfide system was conducted as reported by Freedman (J. Biol Chem, 1949, 181: 601-621). Device 2 or from the PCR vial in Device 4 demonstrate the measurement of electrochemical analytical label on porous matrix or liquid sample. Any electrochemical redox active molecules like aromatic alcohols and amines, aromatic heterocyclic containing non-carbon ring atoms, like, metals, partical oxygen, nitrogen, or sulfur and aromatic and aliphatic thiol-disulfide system or aromatic alcohols and amines or thiols or disulfides; were detectable from the membrane in

### Example 3

### Collection and Removal of Rare Molecules and Cells from Porous Matrix

Blood was collected from healthy donors (9 mL per donor) and stored in Transfix tubes for up to 5 days. The blood sample was spiked with Rare Cells which were SKBR3 human breast cancer cells (ATCC) cell using a stock to give 1000 cells/0.5 mL. The blood sample was also spiked with about 1000 lyzed SKBR3 cells cells into 0.5 mL blood to provide cell free Rare Molecules. The Rare Molecules in these samples were Cytokeratin (CK) proteins and mRNA and Human epidermal growth factor receptor 2 (Her2nue) protein.

Devices 2 and 4 were used with vacuum as a hydrodynamic force to isolate the rare cells and rare molecules using methods and reactions with Analytical label and capture particles according to previous published methods (Pugia et al, in A Novel Strategy for Detection and Enumeration of Circulating Rare Cell Populations in Metastatic Cancer Patients Using Automated Microfluidic Filtration and Multiplex Immunoassay, PLoS ONE 014166 (2015) and Pugia et al, in Tumor Cell Detection by Mass Spectrometry Using Signal Ion Emission Reactive Analytical Chemistry, 2016, 88 (14), 6971-6975).

The sample is diluted and filtered onto a porous matrix with a liquid holding well and then placed on top of the microfluidic surface or Device 2 and a manifold holder use to apply vacuum for the method. The sample was filtered through a porous matrix with pores followed by reactions with affinity agents and other liquids and further filtration. During filtration, sample on the porous matrix was never subjected to a negative mBar. The vacuum applied varied from −10 to −100 mBar during filtration.

In some cases, the diluted sample was placed into the filtration station into the liquid holding well without mixing and the diluted sample was filtered through the porous matrix. In others cases the sample was added in a sample capillary placed at bottom of the additional liquid holding area which was associated with liquid holding area with porous matrix by snapping on top and placed into the filtration station. The sample capillary had a defined area of 10 μL and provided enough capillary force to draw in a 10 μL of blood into the capillary as liquid sample. A dilution buffer (0.5 mL) was added to the top of the additional liquid holding area and a vacuum of 10 millibar was applied to draw the sample and dilution buffer liquid into the liquid holding area with porous matrix as diluted sample. The resultant mixed diluted sample was held in liquid holding well without passing the exit of the microfluidic surface. Application of vacuum of 100 millibar was applied to filter the diluted sample through the porous matrix. In others cases undiluted samples were used and removed at 10 millibar and filtered at 100 millibar.

According to the methods previously described (Pugia et al listed above), samples of Rare Cells or Rare Molecules were collected on the porous matrix by filtration of the sample. In the case of cell free Rare Molecules, capture particles of 1.5 μm diameter with affinity agents for CK or Her2nue were collected onto porous matrix with pores of 0.8 μm diameter. In the case of Rare Cells which had a ˜20 μm diameter, they were collected onto porous matrix with pores of 8.0 μm diameter. The Rare Cells collected contained both CK or Her2nue Rare Molecules as proteins and mRNA.

Prior to affinity reactions, the rare molecule samples on porous matrix were washed with PBS, and the sample was fixed with formaldehyde, washed with PBS, subjected to permeabilization using of 0.2% TRITON® X100 in PBS and washed again with PBS using a vacuum of 100 millibar. A blocking step was employed in which blocking buffer of 10% casein in PBS was dispensed on the Matrix. After an incubation period of 5 min, the matrix was washed with PBS to block non-specific binding to the matrix. During the affinity reactions and any incubation, reagent liquids are held in the liquid holding well without passing the exit of the microfluidic surface without any vacuum. After the affinity reactions, Five PBS TWEEN® surfactant washings were done after each affinity reaction using vacuum of 100 millibar.

The rare molecules and rare cells were then measured using immunoassay reactions with affinity agents for Her2nue or CK proteins and the polypeptide analytical label had 3-9 amino acids detectable as a mass label in accordance to the principles described herein. For cellular Rare Molecule detection, a CK antibody affinity agent at 10 μg/mL conjugated to the analytical label and added to liquid reagent for incubation with the Rare Cell captured on the porous matrix. For the cell free Rare Molecule detection, a first Her2nue antibody affinity agent at 15 μg/mL conjugated to magnetic micro particles of 1.5 um diameter was added to a second Her2nue antibody affinity agent at 10 μg/mL conjugated to the analytical label in liquid reagent and added to the liquid reagent for incubation and the particle captured on the porous matrix with 0.8 μm pore size. Antibody was conjugate to Dylight optical labels 550 as previously described to selectively bind to only rare cells and rare molecules.

The amounts of rare cells and rare molecules contained in the cells were measured by the mass spectrometry method described in Example 2 using the rare cells and affinity agents captured on the porous matrix. All measurements clearly showed that the analytical labels yield information about the presence and amounts of Her2nue or CK proteins as rare molecules over other molecules in the sample. Samples with 10-100 rare cells per porous matrix could be detected through either Her2nue or CK proteins whether cell free rare molecules or cell rare molecules. Little or no background was detected in either samples. Additionally, the porous matrix could be removed from the microfluidic surface, and the bottom surface covered with glass and analyzed by the fluorescent microscope as described Example 2. The entire area of porous matrix was analyzed by the fluorescent signals analyzed by a microscope. The measurements confirmed no analytical label background and showed the analytical label clearly was only on the Rare Cells reacted with affinity agents for rare molecules. The number of cells containing Her2nue or CK proteins were enumerated under the microscope using the positive and negative controls and a single rare cell could be detected.

Additionally, amounts of CK mRNA Rare Molecules on the porous matrix could be measured according to PCR methods previously disclosed in Pugia US 20170137805. Device 4 was used with a clean microfluidic surface to remove the CK mRNA from the porous matrix. For porous matrix containing CK mRNA Rare Cells, the porous matrix was first exposed to a lysis buffer. For cell free CK mRNA, the sample was first reacted with silica particles, followed by particles and CK mRNA capture on the porous matrix and exposed to elution buffer. In both cases the free CK mRNA Rare Molecules were moved to the PCR vial using a centrifuge as a hydrodynamic force to isolate the CK mRNA Rare Molecules for analysis. PCR analysis clearly demonstrated the rare molecules of interest are removed from a liquid holding area and provided into the liquid receiving area. Samples with 10-100 rare cells per porous matrix could be detected through either CK mRNA whether cell free rare molecules or cell rare molecules.

All patents, patent applications and publications cited in this application including all cited references in those patents, applications and publications, are hereby incorporated by reference in their entirety for all purposes to the same extent as if each individual patent, patent application or publication were so individually denoted.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. A method of releasing a liquid from a porous matrix having at least one pore to a microfluidic surface having at least one liquid volume area and at least one exit hole, said method comprising:
(a) filtering said liquid through said porous matrix;
(b) removing said porous matrix and sealing the microfluidic surface having a liquid volume area;
(c) releasing said liquid from the liquid volume area through the exit hole of the microfluidic surface by application of a dynamic force; and
(d) collecting said liquid into a liquid receiving area.

2. The method of claim 1, wherein said liquid is in the form of liquid droplets.

3. The method of claim 1, wherein said dynamic force is a hydrodynamic force.

4. The method of claim 3, wherein said hydrodynamic force includes gravity, vacuum, centrifugal force, air pressure, piezo electric, electrophoretic, electrical field or capillary force.

5. The method of claim 2, wherein said liquid droplets can be retained in the porous matrix and microfluidic surface and then moved onto the liquid receiving area.

6. The method of claim 1, wherein the microfluidic surface exit can be a restricted structure acting as a stop function and requiring a greater hydrodynamic force to move liquid through the exit hole.

7. The method of claim 1, wherein the liquid collection area is a well, vial, surface or inside an analyzer.

8. The method of claim 1. wherein rare cells or rare molecules are isolated on porous media or in liquid droplets into a liquid receiving area.

9. The method of claim 1, where one or more analytical labels are released from the porous matrix to the liquid droplet as an optical, mass spectrographic, or electrochemical analytical measure of rare molecule or rare cells.

10. The method of claim 1, wherein the filtering assembly and microfluid assembly include a cover surface including electrodes, sensors, electric field generators, hydrodynamic force generators and optical protective surfaces needed for analysis, release of analytical label or for generation of hydrodynamic force.

11. The method of claim 1, where the liquid holding area, microfluidic surfaces and liquid receiving area are optionally fitted with sealing a gasket.

12. The method of claim 1, wherein the porous matrix is used for capture of rare cells, rare molecule and particles by size exclusion.

13. The method of claim 1, wherein the liquid holding area, microfluidic surfaces or liquid receiving area can be organized into arrays.

14. The method of claim 1, wherein the liquid holding area holds cell culture media, capture particles, label particles, analytical labels, rare molecules, rare cells, fibrous materials, particles, liquid sample, analysis liquid, liquid reagents and affinity agents.

15. The method of claim 1, wherein the collected liquid filtered through the porous matrix is for used analysis of rare molecules or rare cells.

16. The method of claim 1, wherein the sample can be added via a capillary with a second liquid holding area positioned over the liquid holding area with porous matrix.

17. An apparatus useful for processing liquid samples undergoing analytical assays, said apparatus comprising:
(a) a filtering device having a porous matrix affixed to a support structure;
(b) a microfluidic surface having a liquid volume area and an exit hole connected to said filtering device; and
(c) a liquid receiving area attached to said microfluidic surface.

18. The apparatus of claim 16, further including means for providing a hydrodynamic force to release liquid from the filtering device to the microfluidic surface.

19. A method of releasing liquid droplets from a porous matrix having at least one pore to a microfluidic surface having at least one liquid volume area and at least one exit hole, said method comprising:
(a) filtering said liquid droplets through said porous matrix;
(b) removing said porous matrix and sealing the microfluidic surface having a liquid volume area;
(c) releasing said liquid droplets from the liquid volume area through the exit hole of the microfluidic surface by application of a dynamic force; and
(d) collecting said liquid droplets into a liquid receiving area.

20. A kit useful for conducting analytical assays comprising:
(a) reagents for conducting said assays; and
(b) the apparatus of claim 17.
